(19) United States
(12) Patent Application Publication
(10) Pub. No.: US 2011/0288243 A1
(43) Pub. Date: Nov. 24, 2011

(54) Carbonate Block Copolymers

(76) Inventors: Guenter A. Jueptner, Hammah (DE); David H. Bank, Midland, MI (US); John O. Osby, Lake Jackson, TX (US); Jozef J. Van Dun, Horgen (CH); Theo Dingemans, Leiden (NL); Arkadiusz Kotlewski, Pijnacker (NL)

(21) Appl. No.: 13/105,466

(22) Filed: May 11, 2011

Related U.S. Application Data
(60) Provisional application No. 61/345,632, filed on May 18, 2010.
(60) Provisional application No. 61/346,057, filed on May 19, 2010.
(60) Provisional application No. 61/346,989, filed on May 21, 2010.
(60) Provisional application No. 61/347,856, filed on May 25, 2010.

(51) Int. Cl. C08G 64/38

(52) U.S. Cl. 525/464; 525/467

(57) ABSTRACT

Disclosed are novel carbonate block copolymers and methods of making the same. Some carbonate block copolymers include oligomeric carbonate blocks bonded to one or more silicon-containing non-carbonate block, wherein the silicon-containing non-carbonate block is comprised of a diamine moiety and the carbonate block is joined to the silicon-containing non-carbonate block through a urethane group. Other carbonate block copolymers include oligomeric carbonate blocks bonded to one or more non-silicon-containing non-carbonate block, wherein the non-silicon-containing non-carbonate block is comprised of a diamine moiety and the carbonate block is joined to the non-silicon-containing non-carbonate block through a urethane group. The carbonate block may include Bisphenol-A moieties. The diamine from which either the silicon-containing or non-silicon-containing non-carbonate block is derived may be primary, secondary or tertiary.

This application claims priority to each of U.S. Application No. 61/345,632 filed May 18, 2010, U.S. Application No. 61/346,057 filed May 19, 2010, U.S. Application No. 61/346,989 filed May 21, 2010, and U.S. Application No. 61/347,856 filed May 25, 2010, the entire contents of each are hereby incorporated by reference.

### FIELD OF THE INVENTION

This invention belongs to the field of carbonate block copolymers. In one embodiment, it relates to a carbonate block copolymer comprising oligomeric carbonate blocks bonded to one or more silicon-containing non-carbonate block, wherein the silicon-containing non-carbonate block is comprised of a diamine moiety and the carbonate block is joined to the silicon-containing non-carbonate block through a urethane group and to a method of making the carbonate-block copolymer. Preferably the carbonate block is comprised of Bisphenol-A moieties and the silicon-containing non-carbonate block contains a poly(alkyl)siloxane, preferably poly(dimethyl)siloxane.

In another embodiment, the present invention relates to a carbonate block copolymer comprising oligomeric carbonate blocks bonded to one or more non-silicon-containing non-carbonate block, wherein the non-silicon-containing non-carbonate block is comprised of a diamine moiety and the carbonate block is joined to the non-silicon-containing non-carbonate block through a urethane group and to a method of making the carbonate block copolymer with a non-silicon-containing non-carbonate block. Preferably the carbonate block is comprised of Bisphenol-A moieties.

### BACKGROUND OF THE INVENTION

Polycarbonates are well known for their excellent clarity, toughness, and heat resistance. However, as an amorphous material, above a certain critical thickness, typically between 3 millimeter (mm) to 6 mm, the polycarbonate loses its impact strength and becomes rather weak and brittle. Additionally, polycarbonates are quite sensitive to certain environmental stresses such as exposure to organic solvents. Exposure to such solvents may induce formation of cracks, or crazes, and drastically reduce the mechanical and optical properties at thicknesses less than 3 mm.

Many blends of polycarbonate with other polymers have been developed in an attempt to improve these properties in polycarbonate. Some of these blends have met with significant degree of success. However these admixtures can create new problems. In order for an admixture to be successful, the composition must be compatible. The admixture components should mix and maintain the blend integrity upon molding. This is evidenced by little or no delamination in the molded part and an impact resistant, ductile knit line when a molded part is formed in a mold having two ports of entry for the thermoplastic admixture (double gate test system).

Alternatively, polycarbonate copolymers have been developed to improve such properties of polycarbonate. Some of these copolymers comprise one or more comonomer randomly copolymerized with a dihydric diol to form a random carbonate copolymer. Another approach is the copolymerization of carbonate blocks with a different monomer or oligomer block, for instance, one or more of a polyester block, a polyurethane block, a polyamide block, a polysiloxane block, and the like, to form a carbonate block copolymer.

It is well known that semi-crystalline polymers display improved solvent resistance as compared to their amorphous counterparts. Incorporation of semi-crystalline blocks into the polymer backbone by chemical means provides an opportunity to control the degree of crystallinity. For example, carbonate block copolymers have been disclosed in the following:

U.S. Pat. No. 3,450,793 describes polymerization of polycarbonate oligomers with polyurethane oligomers to form a block copolymer comprised of urethane blocks having a molecular weight of from 1,500 to 30,000 grams per mole with carbonate blocks in a ratio of urethane blocks:carbonate blocks of from 1:9 to 1:10,000;

U.S. Pat. No. 5,194,524 describes a melt polymerization process to make a carbonate siloxane block copolymer wherein the siloxane comprises a secondary amine. When melt polymerized into the carbonate backbone, said siloxane block forms on one end an oxygen-silicon-oxygen bond and on the other end a nitrogen-carbon-oxygen bond;

U.S. Pat. No. 4,766,199 discloses a melt polymerization process to make copolyuethanecarbonates from amine-terminated aromatic oligomers and cyclic polycarbonate oligomers. Said process is limited exclusively to cyclic polycarbonate oligomers and to a melt polymerization process;

EP16543301 discloses a method to make copolyorganosiloxanecarbonate block copolymer by reacting an oligomeric aromatic polycarbonate with a polyorganosiloxane bis(aryl)chloroformate;

U.S. Pat. No. 4,945,148 discloses a process to make a silicon-polycarbonate block copolymer by phosgenating a mixture of a hydroxyarylimide siloxane, hydroxarylester siloxane, or mixtures thereof, with a dihydric phenol by a condensation reaction mechanism; and

U.S. Pat. No. 4,111,910 discloses a high molecular weight polycarbonate terminated with carbamate end groups.

A new carbonate block copolymer composition has been discovered which demonstrates substantially improved organic solvent resistance in combination with good rheological, ignition resistant, weatherability, thermal, and/or physical properties.

### SUMMARY OF THE INVENTION

The present invention provides carbonate block copolymers.

In one embodiment, the present invention is a urethane carbonate block copolymer composition comprising a urethane carbonate copolymer which comprises:

I) from 99.5 to 50 weight percent of repeating or reoccurring carbonate oligomer block units of the formula I:

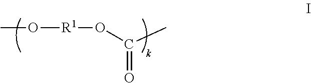

wherein

R¹ is a divalent aromatic residue of a dihydric phenol, preferably the divalent aromatic residue of the dihydric phenol Bisphenol-A

and

k is an integer having an average value of from 2 to 25,

and

(II) from 0.5 to 50 weight percent of a silicon-containing non-carbonate block of the formula II:

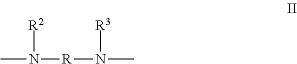

wherein

R is a poly(alkyl)siloxane of the formula VIII:

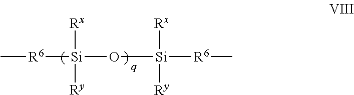

wherein

R⁶ is a C₂ to C₈ divalent aliphatic radical, preferably methylene, ethylene, propylene, isopropylene, n-butylene, isobutylene, pentene, hexene, octene, or dodecene;

R^{x} and R^{y} are independently C₁ to C₁₃ monovalent organic radicals, a C₁ to C₈ alkyl radical, a fluoroalkyl radical, an aryl radical, or mixtures thereof, more preferably phenyl, tolyl, methyl, ethyl, propyl, trifluoromethyl, trifluoropropyl, or a mixtures thereof;

and

q is an integer from 1 to 100,

and

R² and R³ are independently hydrogen, a monovalent linear C₁ to C₂₅ aliphatic radical, a monovalent branched C₁ to C₂₅ aliphatic radical, a cyclic aliphatic C₁ to C₂₅ hydrocarbon organic radical, an aromatic C₅ to C₂₅ radical comprising one or more aromatic rings, an alkyl-aryl C₅ to C₂₅ radical wherein the aliphatic, aromatic, and/or alkyl-aryl radical may comprise one or more or a combination of an alcohol, ketone, ester, ether, aldehyde, or oxirane more preferably R² and R³ are independently hydrogen, methyl, ethyl, propyl, butyl, pentyl, hexyl, cyclohexyl, cyclooctyl, or cyclododecyl, wherein the silicon-containing non-carbonate block is a diamine and each carbonate oligomer block joined to a silicon-containing non-carbonate block is joined through a urethane group.

In one embodiment of the present invention, the silicon-containing non-carbonate block of the urethane carbonate block copolymer disclosed hereinabove is a divalent residue from a primary diamine, a secondary diamine, or a tertiary diamine.

The present invention also contemplates an interfacial process for producing a urethane carbonate block copolymer from a dihydric phenol, a carbonate precursor, a silicon-containing diamine, a chain terminator, a coupling catalyst, and optionally a branching agent which process comprises the steps of:
a) combining a dihydric phenol, preferably Bisphenol-A, base, and water to form a polymerization reaction mixture,
b) adding a carbonate precursor, preferably phosgene and a water immiscible organic solvent to the polymerization reaction mixture,
c) partially oligomerizing the dihydric phenol in the polymerization reaction mixture b) to oligomeric carbonate mono- and bis-chloroformates with repeating units of from 2 to 25,
d) adding a chain terminator,
e) adding a silicon-containing diamine,
f) optionally adding a branching agent,
g) adding a coupling catalyst,
h) completing the polymerization reaction,

and
i) obtaining the urethane carbonate block copolymer.

In one embodiment of the herein above disclosed interfacial process for producing a urethane carbonate block copolymer, the silicon-containing diamine is a primary diamine or a secondary diamine.

In one embodiment of the herein above disclosed interfacial process for producing a urethane carbonate block copolymer, the silicon-containing diamine a tertiary amine and further comprises the step of:
j) adding a Hofmann degradation catalysis, preferably NaBr, NaI, KBr, KI, LiBr, LiI, MgBr₂, MgI₂, CaBr₂, or CaI₂ before, during, or after the addition of the tertiary non-silicon-containing diamine.

In one embodiment of the herein above disclosed interfacial process for producing a urethane carbonate block copolymer, the silicon-containing diamine is represented by the formula VII:

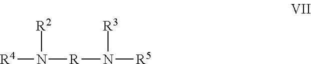

wherein

R², R³, R⁴, and R⁵ are independently hydrogen; a monovalent aliphatic radical such as a linear, branched, and/or cyclic aliphatic C₁ to C₂₅ hydrocarbon organic radicals, preferably methyl, ethyl, propyl, butyl, pentyl, hexyl, cyclohexyl, cyclooctyl, cyclododecyl; and/or an aromatic C₅ to C₂₅ radical comprising one or more aromatic rings, and/or an alkyl-aryl C₅ to C₂₅ radical wherein the aliphatic, aromatic, and/or alkyl-aryl radical may comprise one or more or a combination of an alcohol, ketone, ester, ether, aldehyde, oxirane;

and

R comprises a poly(alkyl)siloxane represented by the following formula VIII:

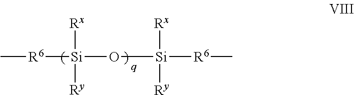

wherein

R6 is a C2 to C8 divalent aliphatic radical;

R^{x} and R^{y} are independently C₁ to C₁₃ monovalent organic radicals; preferably C₁ to C₈ alkyl radical, a fluoroalkyl radical, an aryl radical, or mixtures thereof; more preferably phenyl, tolyl, methyl, ethyl, propyl, trifluoromethyl, trifluoropropyl, or a mixtures thereof.

and

q is an integer from 1 to 100.

In preferred embodiment of the herein above disclosed interfacial process for producing a urethane carbonate block copolymer, the poly(alkyl)siloxane R is a polydimethylsiloxane where in R⁶ is methylene, ethylene, propylene, isopropylene, n-butylene, isobutylene, pentene, hexene, octene, or dodecene.

In preferred embodiment of the herein above disclosed interfacial process for producing a urethane carbonate block copolymer, R² and R³ are independently hydrogen, methyl, ethyl, propyl, butyl, pentyl, hexyl, cyclohexyl, cyclooctyl, or cyclododecyl.

In another embodiment, the present invention is a urethane carbonate block copolymer composition comprising a urethane carbonate block copolymer which comprises

I) from 99.5 to 30 weight percent of a repeating or reoccurring carbonate oligomer block units of the formula:

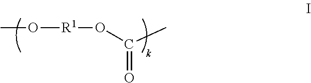

wherein

R¹ is a divalent aromatic residue of a dihydric phenol, preferably the divalent aromatic residue of the dihydric phenol Bisphenol-A

and

k is an integer having an average value of from 2 to 25, and

II) from 0.5 to 70 weight percent of a non-silicon-containing non-carbonate block of the formula:

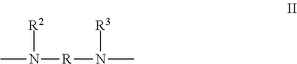

wherein

R is a linear or branched alkyl, aryl, or alkyl-aryl C₁ to C₂₅ hydrocarbon diradical, wherein the aliphatic, aromatic, and/or alkyl-aryl diradical may comprise one or more or a combination of an alcohol, ketone, ester, ether, aldehyde, oxirane, mercapto, S, —SO—, or —SO₂— groups; the alkyl and/or alkyl-aryl moieties may comprise one or more unsaturated bond; a heterocyclic diamine wherein the ring structure comprises the nitrogens of the diamine, such as piperazine, amino tetrahydropyrrol, amino pyrrolidin, amino indol, amino isantine, amino carbazol, gramine, tryptamine, hydantoin, amino oxazolane, amino oxazolindine, or amino thiazole, preferably R is methyl, ethyl, propyl, butyl, pentyl, hexyl, heptyl, octyl, nonyl, undecyl, decyl, dodecyl, octadecyl, nonodecyl eicosyl, heneicosyl, docosyl, tricosyl, tetracosyl, pentacosyl, phenyl, tolyl, xylyl, napthyl, biphenyl, tetraphenyl, benzyl, phenethyl, phenpropyl, phenbutyl, phenhexyl, napthoctyl, cyclopropyl, cyclobutyl, cyclopentyl, cyclohexyl, cycloheptyl, or cyclooctyl.

and

R² and R³ are independently hydrogen, a monovalent linear C₁ to C₂₅ aliphatic radical, a monovalent branched C₁ to C₂₅ aliphatic radical, a cyclic aliphatic C₁ to C₂₅ hydrocarbon organic radical, an aromatic C₅ to C₂₅ radical comprising one or more aromatic rings, an alkyl-aryl C₅ to C₂₅ radical wherein the aliphatic, aromatic, and/or alkyl-aryl radical may comprise one or more or a combination of an alcohol, ketone, ester, ether, aldehyde, or oxirane, preferably independently hydrogen, methyl, ethyl, propyl, butyl, pentyl, hexyl, cyclohexyl, cyclooctyl, or cyclododecyl wherein the non-silicon-containing non-carbonate block is a diamine and each carbonate oligomer block joined to a non-silicon-containing non-carbonate block is joined through a urethane group.

In another embodiment of the present invention, R of the urethane carbonate block copolymer disclosed herein above is represented by the formula IX:

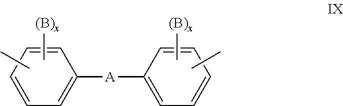

wherein

A denotes a single bond, a C₁-C₅ alkylene, a C₂-C₅ alkylidene, a C₅-C₆ cycloalkylidene, —O—, —SO—, —CO—, —S—, —SO₂—, or a C₆-C₁₂ arylene, on to which other aromatic rings, which optionally contain hetero atoms, can be condensed, or a radical of formula V or VI:

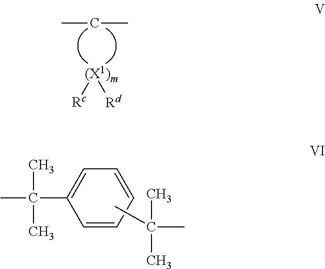

B in each case is independently hydrogen, a C₁-C₁₂ alkyl, preferably methyl, or a halogen, preferably chlorine and/or bromine;

x in each case is mutually independently 0, 1, 2, or 4;

p is 0 or 1;

R^{c} and R^{d} are mutually independent of each other and are individually selectable for each X¹ and are hydrogen or a C₁-C₆ alkyl, preferably hydrogen, methyl or ethyl;

X¹ denotes carbon;

and

m denotes an integer from 4 to 7, preferably 4 or 5, with the proviso that R^{c} and R^{d} simultaneously denote an alkyl on at least one X₁ atom.

In one embodiment of the present invention, the non-silicon-containing non-carbonate block of the urethane carbonate block copolymer disclosed herein above is a divalent residue from a primary diamine, a secondary diamine, or a tertiary diamine.

In yet another embodiment of the present invention, the diamine of the urethane carbonate block copolymer disclosed herein above is selected from ethylenediamine, propylenediamine, butylenediamine, pentylenediamine, hexylenediamine, octylenediamine, N,N′-dimethyl ethane diamine, N,N′-dimethyl is propane diamine, N,N′-dimethyl hexane diamine, polyether amines, amino tetra hydropyrrol, amino pyrrolidin, amino indol, amino isantine, amino carbazol, gramine, tryptamine, hydantoin, amino oxazolane, amino oxazolindine, and amino thiazole, piperazin, amino piperidine, cytosine, uracil, thymine, amino morpholine, amino thiazine, xanthine, guanine, N-methyl piperazine, N,N′-dimethyl piperazine, N-ethyl piperazine, N,N′-diethyl piperazine, N-propyl piperazine, or N,N′-dipropyl piperazine.

In one embodiment, the present invention is an interfacial process for producing a urethane carbonate block copolymer from a dihydric phenol, a carbonate precursor, a non-silicon-containing diamine, a chain terminator, a coupling catalyst, and optionally a branching agent which process comprises the steps of:
a) combining a dihydric phenol, preferably Bisphenol-A, base, and water to form a polymerization reaction mixture,
b) adding a carbonate precursor, preferably phosgene and a water immiscible organic solvent to the polymerization reaction mixture,
c) partially oligomerizing the dihydric phenol in the polymerization reaction mixture b) to oligomeric carbonate mono- and bis-chloroformates with repeating units of from 2 to 25,
d) adding a chain terminator,
e) adding a non-silicon-containing diamine,
f) optionally adding a branching agent,
g) adding a coupling catalyst,
h) completing the polymerization reaction,

and
i) obtaining the urethane carbonate block copolymer.

In one embodiment of the herein above disclosed interfacial process for producing a urethane carbonate block copolymer, the non-silicon-containing diamine is a primary diamine or a secondary diamine.

In one embodiment of the herein above disclosed interfacial process for producing a urethane carbonate block copolymer, the non-silicon-containing diamine is a tertiary amine and further comprises the step of:
j) adding a Hofmann degradation catalysis, preferably NaBr, NaI, KBr, KI, LiBr, LiI, MgBr₂, MgI₂, CaBr₂, or CaI₂ before, during, or after the addition of the tertiary non-silicon-containing diamine.

In one embodiment of the herein above disclosed interfacial process for producing a urethane carbonate block copolymer, the non-silicon-containing diamine is selected from ethylenediamine, propylenediamine, butylenediamine, pentylenediamine, hexylenediamine, octylenediamine, N,N′-dimethyl ethane diamine, N,N′-dimethyl propane diamine, N,N′-dimethyl hexane diamine, polyether amines, amino tetra hydropyrrol, amino pyrrolidin, amino indol, amino isantine, amino carbazol, gramine, tryptamine, hydantoin, amino oxazolane, amino oxazolindine, and amino thiazole, piperazin, amino piperidine, cytosine, uracil, thymine, amino morpholine, amino thiazine, xanthine, guanine, N-methyl piperazine, N,N′-dimethyl piperazine, N-ethyl piperazine, N,N′-diethyl piperazine, N-propyl piperazine, or N,N′-dipropyl piperazine.

In one embodiment of the herein above disclosed interfacial process for producing a urethane carbonate block copolymer, the non-silicon-containing diamine represented by the formula VII:

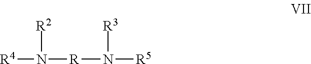

wherein

R², R³, R⁴, and R⁵ are independently hydrogen; a monovalent aliphatic radical such as a linear, branched, and/or cyclic aliphatic C₁ to C₂₅ hydrocarbon organic radicals, preferably methyl, ethyl, propyl, butyl, pentyl, hexyl, cyclohexyl, cyclooctyl, cyclododecyl; and/or an aromatic C₅ to C₂₅ radical comprising one or more aromatic rings, and/or an alkyl-aryl C₅ to C₂₅ radical wherein the aliphatic, aromatic, and/or alkyl-aryl radical may comprise one or more or a combination of an alcohol, ketone, ester, ether, aldehyde, oxirane;

and

R is selected from a linear or branched alkyl, aryl, or alkyl-aryl C₁ to C₂₅ hydrocarbon diradical, wherein the aliphatic, aromatic, and/or alkyl-aryl diradical may comprise one or more or a combination of an alcohol, ketone, ester, ether, aldehyde, oxirane, mercapto, S, —SO—, or —SO₂— groups; the alkyl and/or alkyl-aryl moieties may comprise one or more unsaturated bond; a heterocyclic diamine wherein the ring structure comprises the nitrogens of the diamine, such as piperazine, amino tetra hydropyrrol, amino pyrrolidin, amino indol, amino isantine, amino carbazol, gramine, tryptamine, hydantoin, amino oxazolane, amino oxazolindine, or amino thiazole, preferably methyl, ethyl, propyl, butyl, pentyl, hexyl, heptyl, octyl, nonyl, undecyl, decyl, dodecyl, octadecyl, nonodecyl eicosyl, heneicosyl, docosyl, tricosyl, tetracosyl, pentacosyl, phenyl, tolyl, xylyl, napthyl, biphenyl, tetraphenyl, benzyl, phenethyl, phenpropyl, phenbutyl, phenhexyl, napthoctyl, cyclopropyl, cyclobutyl, cyclopentyl, cyclohexyl, cycloheptyl, or cyclooctyl.

In one embodiment of the herein above disclosed interfacial process for producing a urethane carbonate block copolymer, R is represented by the formula IX:

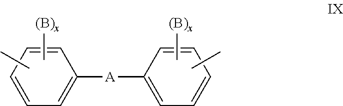

wherein

A denotes a single bond, a C₁-C₅ alkylene, a C₂-C₅ alkylidene, a C₅-C₆ cycloalkylidene, —O—, —SO—, —CO—, —S—, —SO₂—, or a C₆-C₁₂ arylene, on to which other aromatic rings, which optionally contain hetero atoms, can be condensed, or a radical of formula V or VI:

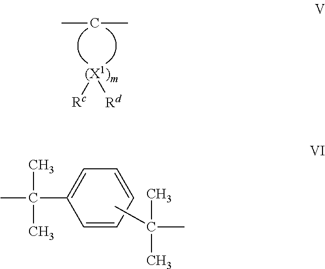

wherein

B in each case is independently hydrogen, a C₁-C₁₂ alkyl, preferably methyl, or a halogen, preferably chlorine and/or bromine;

x in each case is mutually independently 0, 1, 2, or 4;

p is 0 or 1;

R^{c} and R^{d} are mutually independent of each other and are individually selectable for each X¹ and are hydrogen or a C₁-C₆ alkyl, preferably hydrogen, methyl or ethyl;

X¹ denotes carbon;

and

m denotes an integer from 4 to 7, preferably 4 or 5, with the proviso that R^{c} and

R^{d} simultaneously denote an alkyl on at least one X₁ atom.

### BRIEF DESCRIPTION OF THE DRAWINGS

FIG. 1 is a flow chart illustrating the interfacial process for producing a carbonate block copolymer of the present invention.

FIG. 2 is a reaction scheme showing the polymerization of a carbonate block copolymer of the present invention using bisphenol A and a generic primary/secondary diamine.

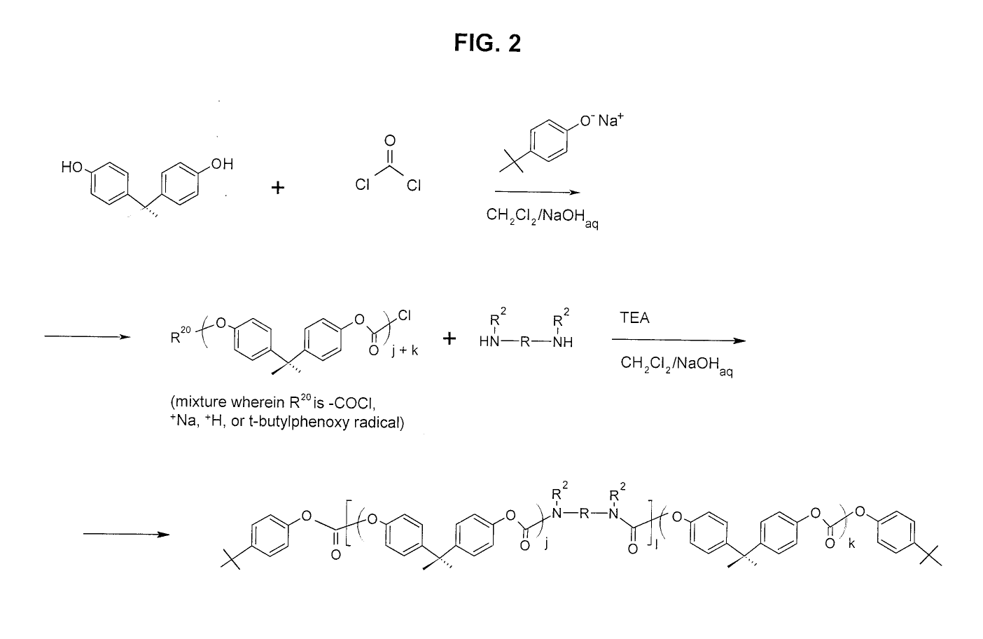

FIG. 3 is a reaction scheme of the present invention using bisphenol A and a primary diamine comprising a 1,6-hexamethylene radical.

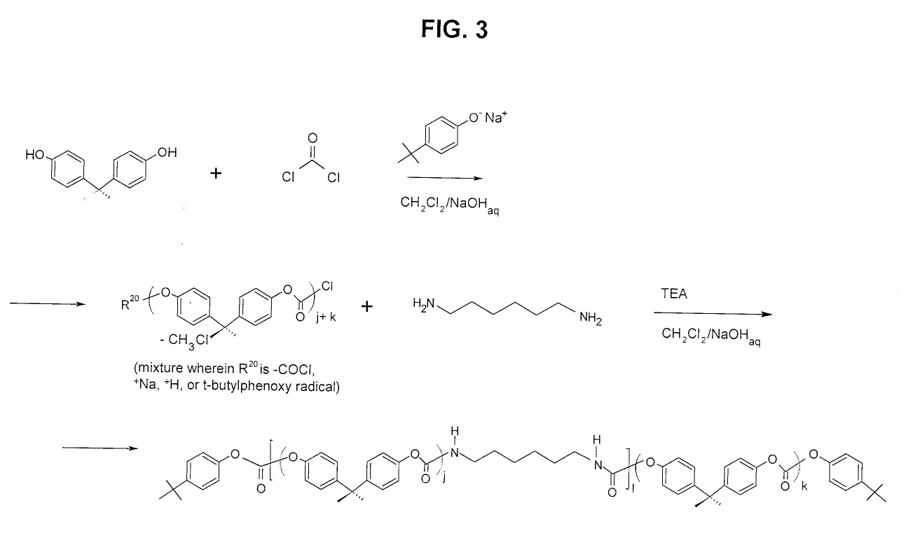

FIG. 4 is a reaction scheme of the present invention using bisphenol A and a secondary N,N′-dimethyl diamine comprising a 1,6-hexamethylene radical.

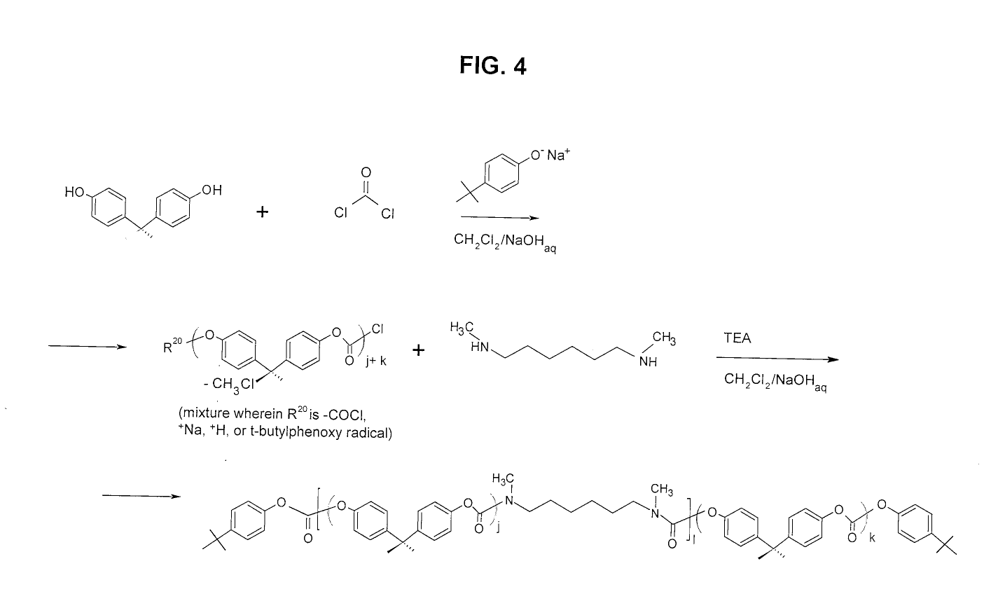

FIG. 5 is a reaction scheme of the present invention using bisphenol A and a primary diamine comprising an isobutylpolydimethysiloxyl radical.

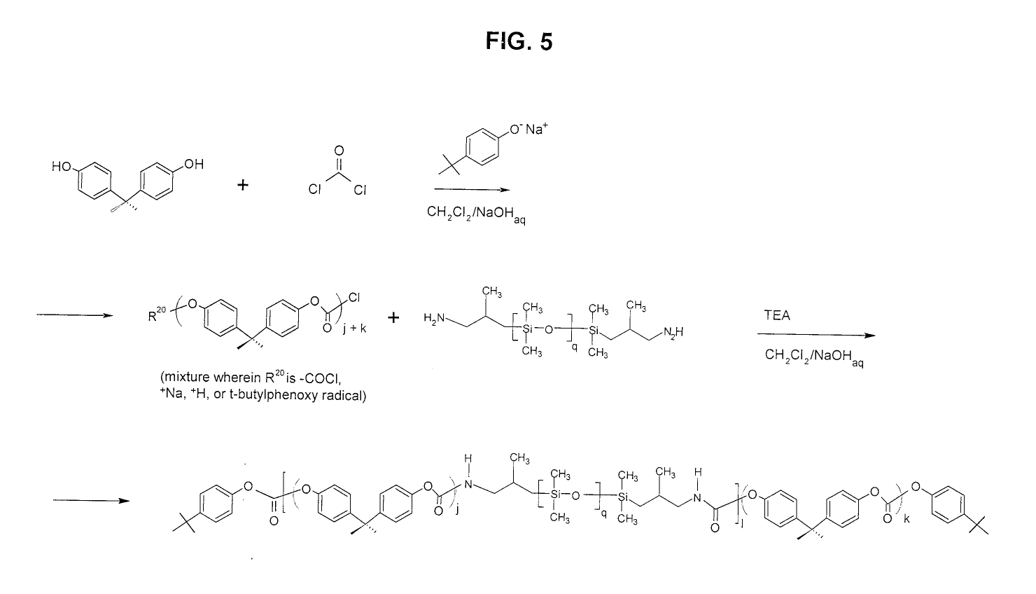

FIG. 6 is a reaction scheme of the present invention using bisphenol A and a secondary N,N′-diethyl diamine comprising an isobutylpolydimethysiloxyl radical.

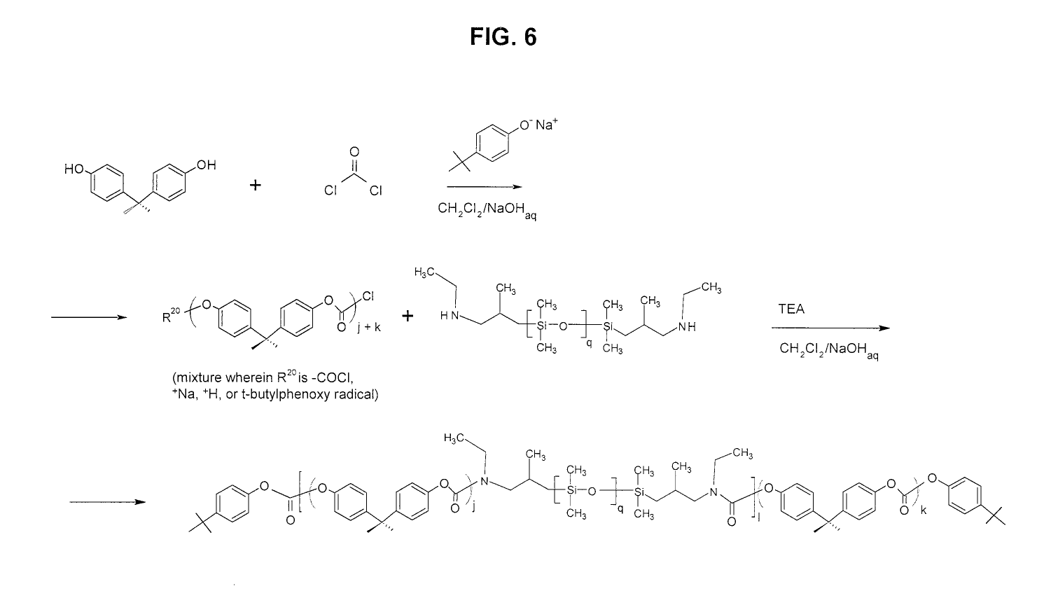

FIG. 7 is a reaction scheme is a reaction scheme showing the polymerization of a carbonate block copolymer of the present invention using a generic tertiary diamine.

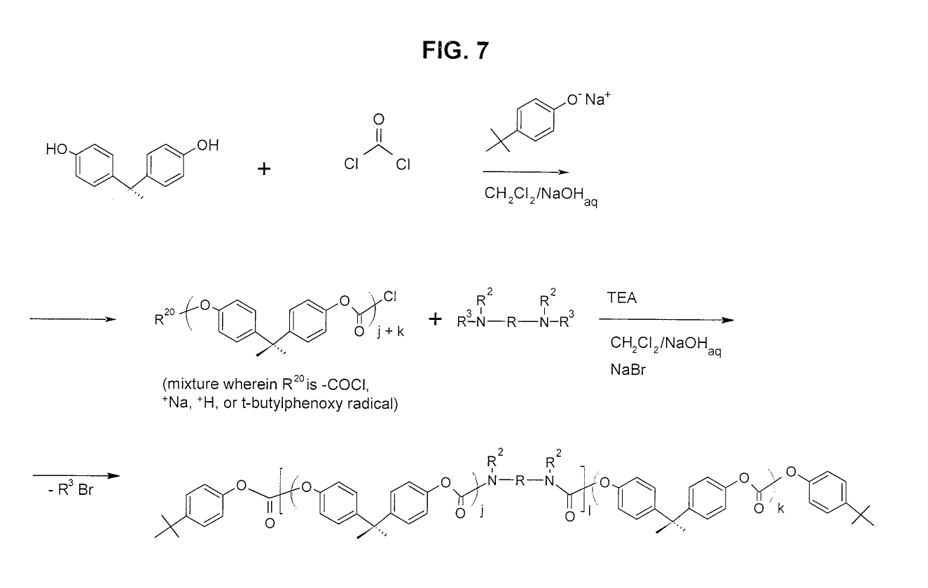

FIG. 8 is a reaction scheme of the present using bisphenol A and a tertiary N,N,N′,N′-tetra methyl diamine comprising a 1,6-hexamethylene radical.

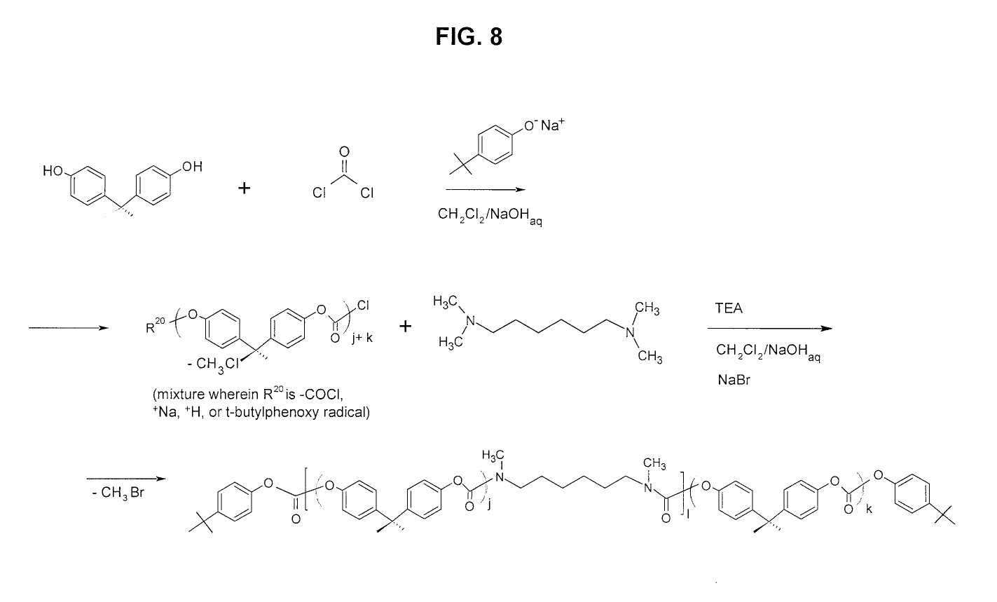

FIG. 9 is a reaction scheme of the present invention using bisphenol A and a tertiary N,N,N′,N′-tetraethyl diamine comprising a propylpolydimethysiloxyl radical.

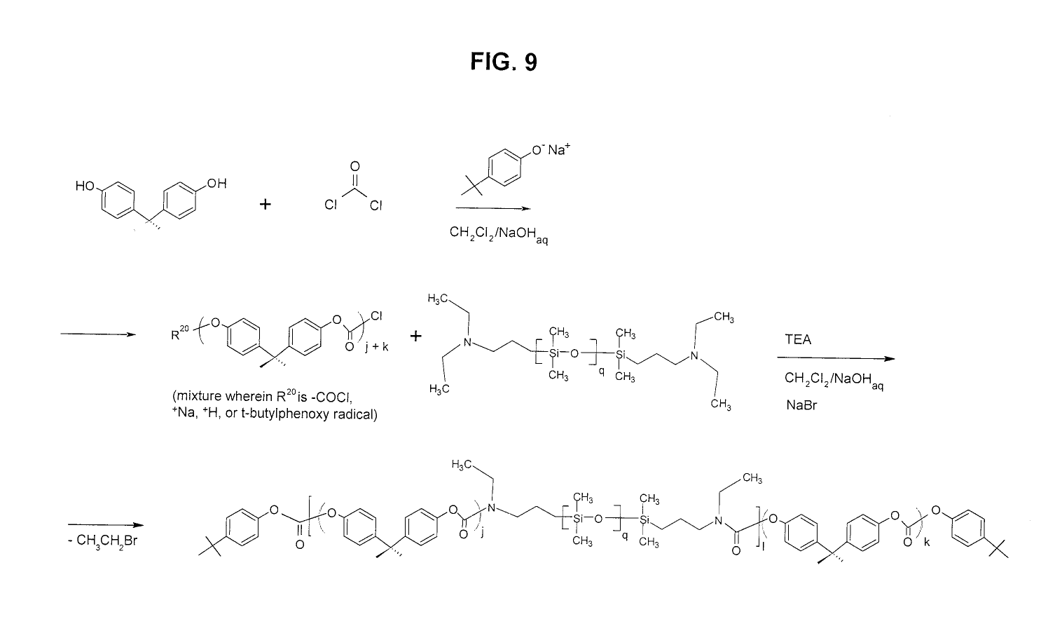

### DETAILED DESCRIPTION OF THE INVENTION

Unless otherwise stated, “weight percent” in reference to the composition of a polycarbonate in this specification is based upon 100 weight percent of the repeating diphenolic residue units of the polycarbonate. For instance, “a polycarbonate comprising 90 weight percent of Bisphenol-A” refers to a polycarbonate in which 90 weight percent of the repeating units are residues derived from Bisphenol-A or its corresponding derivative(s). Corresponding derivatives include, but are not limited to, corresponding oligomers of the diphenols; corresponding esters of the diphenol and their oligomers; and the corresponding chloroformates of the diphenol and their oligomers.

The present invention a carbonate block copolymer comprising oligomeric carbonate blocks I bonded to one or more non-carbonate block, wherein the non-carbonate block is comprised of a diamine moiety II and the carbonate block is joined to the non-carbonate block through a urethane group.

Carbonate block copolymer compositions of the present invention are represented by formula III. It is to be understood that there are I number repeating or reoccurring units of I joined to II through a urethane bond, wherein I is an integer of from 1 to 100, preferably 5 to 15. The designations of k and j are illustrative of the number of repeating monomers in the oligomeric chain for each oligomeric carbonate block while the actual number in each oligomeric carbonate block is defined as an integer falling within the average range of from 2 to 25. In other words, the values for j and k vary with each oligomeric carbonate block, for instance, k for one oligomeric carbonate block may be 3 while the k value for a different oligomeric carbonate block may be 16 and the j value for one oligomeric carbonate block may be 10 and 7 in another oligomeric carbonate block. Further, it is understood that there may be one or more carbonate oligomer blocks in the urethane carbonate block copolymer of the present invention having an individual k value greater than 25.

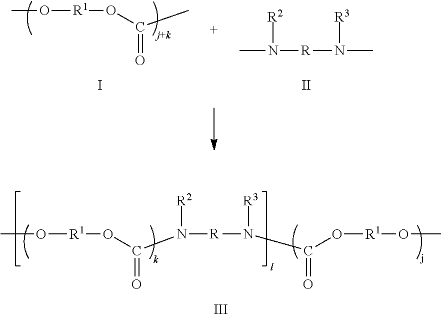

Component I) is one or more oligomeric carbonate block made from one or more dihydric phenol. The dihydric phenols employed in the practice of the present invention are generally known in the carbonate polymerization art and in which the only reactive groups under condensation polymerization conditions are the two phenolic hydroxyl groups. Useful dihydric phenols are for example those of the general formula HO—Z—OH, wherein Z comprises a mono- or poly-aromatic diradical of 5-30 carbon atoms, to which the phenolic oxygen atoms are directly linked. The aromatic group(s) may comprise one or more heteroatoms and may be substituted with one or more groups, for example one or more oxygens, nitrogens, sulfur, phosphorous and/or halogens, one or more monovalent hydrocarbon radicals, such as one or more alkyl, cycloalkyl or aryl groups and/or one or more alkoxy and/or aryloxy groups. Preferably, both phenolic hydroxy groups in the dihydric phenol HO—Z—OH are arranged in para-positions on the aromatic ring(s).

The dihydric phenols useful for the production of the oligomeric carbonate block are preferably those of formula IV:

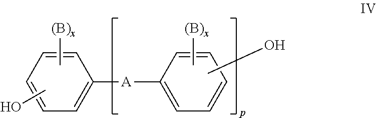

wherein A denotes a single bond, a C₁-C₅ alkylene, a C₂-C₅ alkylidene, a C₅-C₆ cycloalkylidene, —O—, —SO—, —CO—, —S—, —SO₂—, or a C₆-C₁₂ arylene, on to which other aromatic rings, which optionally contain hetero atoms, can be condensed, or a radical of formula V or VI:

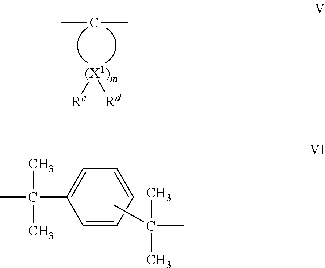

wherein

B in each case is independently hydrogen, a C₁-C₁₂ alkyl, preferably methyl, or a halogen, preferably chlorine and/or bromine;

x in each case is mutually independently 0, 1, 2, or 4;

p is 0 or 1;

R^{c} and R^{d} are mutually independent of each other and are individually selectable for each X¹ and are hydrogen or a C₁-C₆ alkyl, preferably hydrogen, methyl or ethyl;

X¹ denotes carbon; and

m denotes an integer from 4 to 7, preferably 4 or 5, with the proviso that R^{c} and

R^{d} simultaneously denote an alkyl on at least one X₁ atom.

Preferably, the dihydric phenol used in the oligomeric block of the present invention is 2,2-bis(4-hydroxyphenyl)propane (BPI). Optionally, in addition to comprising BPA residues, the oligomeric carbonate block further comprised one or more of other dihydric phenol compound residues in an amount of from 0.1 weight percent up to about 99.9 weight percent of the repeating units in the oligomeric carbonate block, and/or completely replacing the Bisphenol-A as the dihydric phenol.

Examples of such dihydric phenol compounds include the following: resorcinol; 4-bromoresorcinol; hydroquinone; 4,4′-dihydroxybiphenyl ether; 4,4-thiodiphenol 1,6-dihydroxynaphthalene; 2,6-dihydroxynaphthalene; bis(4-hydroxyphenyl)methane; bis(4-hydroxyphenyl)diphenylmethane; bis(4-hydroxyphenyl)-1-naphthylmethane; 1,1-bis(4-hydroxyphenyl)ethane; 1,1-bis(4-hydroxyphenyl)propane; 1,2-bis(4-hydroxyphenyl)ethane; 1,1-bis(4-hydroxyphenyl)-1-phenylethane; 1,1-bis(3-methyl-4-hydroxyphenyl)-1-phenylethane, 2-(4-hydroxyphenyl)-2-)3-hydroxyphenyl)propane; 2,2-bis(4-hydroxyphenyl)butane; 1,1-bis(4-hydroxyphenyl)isobutane; 1,1-bis(4-hydroxyphenyl)decane; 1,1-bis(3,5-dimethyl-4-hydroxyphenyl)cyclohexane; 1,1-bis(3,5-dibromo-4-hydroxyphenyl)cyclohexane; 1,1-bis(4-hydroxyphenyl)cyclohexane; 1,1-bis(4-hydroxyphenyl)cyclododecane; 1,1-bis(3,5-dimethyl-4-hydroxyphenyl)cyclododecane; trans-2,3-bis(4-hydroxyphenyl)-2-butene; 4,4-dihydroxy-3,3-dichlorodiphenyl ether; 4,4-dihydroxy-2,5-dihydroxy diphenyl ether; 2,2-bis(4-hydroxyphenyl)adamantane; α,α-bis(4-hydroxyphenyl)toluene bis(4-hydroxyphenyl)acetonitrile; 2,2-bis(3-methyl-4-hydroxyphenyl)propane; 2,2-bis(3-ethyl-4-hydroxyphenyl)propane; 2,2-bis(3-n-propyl-4-hydroxyphenyl)propane; 2,2-bis(3-isopropyl-4-hydroxyphenyl)propane; 2,2-bis(3-sec-butyl-4-hydroxyphenyl)propane; 2,2-bis(3-t-butyl-4-hydroxyphenyl)propane; 2,2-bis(3-cyclohexyl-4-hydroxyphenyl)propane; 2,2-bis(3-allyl-4-hydroxyphenyl)propane; 2,2-bis(3-methoxy-4-hydroxyphenyl)propane; 2,2-bis(3,5-dimethyl-4-hydroxyphenyl)propane; 2,2-bis(2,3,5,6-tetramethyl-4-hydroxyphenyl)propane, 2,2-bis(3-5-dichloro-4-hydroxyphenyl)propane; 2,2-bis(3,5-dibromo-4-hydroxyphenyl)propane; 2,2-bis(2,6-dibromo-3,5-dimethyl-4-hydroxyphenyl)propane, α,α-bis(4-hydroxyphenyl)toluene; α,α,α,α-tetramethyl α,α-bis(4-hydroxyphenyl)-p-xylene; 1,1-dichloro-2,2-bis(4-hydroxyphenyl)ethylene; 1,1-dibromo-2,2-bis(4-hydroxyphenyl)ethylene; 1,1-dichloro-2,2-bis(5-phenoxy-4-hydroxyphenyl)ethylene; 4,4′-dihydroxybenzophenone 3,3-bis(4-hydroxyphenyl)-2-butanone; 1,6-bis(4-hydroxyphenyl)-1,6-hexanedione ethylene glycol bis(4-hydroxyphenyl)ether; bis(4-hydroxyphenyl)ether; bis(4-hydroxyphenyl)sulfide; bis(4-hydroxyphenyl)sulfoxide; bis(4-hydroxyphenyl)sulfone; bis(3,5-dimethyl-4-hydroxyphenyl)sulfone; 9,9-bis(4-hydroxyphenyl)fluorene; 2,7-dihydroxypyrene 6,6′-dihydroxy-3,3,3′,3′-tetramethylspiro(bis)indane (“spirobiindane bisphenol”); 3,3-bis(4-hydroxyphenyl)phthalide; 2,6-dihydroxydibenzo-p-dioxin; 2,6-dihydroxythianthrene 2,7-dihydroxyphenoxathiin; 2,7-dihydroxy-9,10-dimethylphenazine 3,6-dihydroxydibenzofuran; 3,6-dihydroxydibenzothiophene; or 2,7-dihydroxycarbazole.

The dihydric phenols may be used alone or as mixtures of two or more dihydric phenols. Further illustrative examples of dihydric phenols include the dihydroxy-substituted aromatic hydrocarbons disclosed in U.S. Pat. No. 4,217,438.

The oligomeric carbonate block of the present invention is made up or repeating dihydric phenol moieties represented by the following formula I:

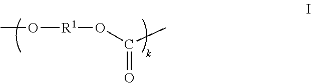

wherein

R¹ represents a divalent aromatic residue of the dihydric phenol, such as one derived from the dihydric phenol represented by formula IV and

k an integer from 2 to 25, preferably from 5 to 25, and more preferably from 10 to 20, more preferably 10 to 15.

When the carbonate block copolymer of the present invention does not contain silicon in the non-carbonate block(s) Component II), the oligomeric carbonate block(s) Component I) is present in an amount equal to or greater than about 30 weight percent, preferably equal to or greater than about 40 weight percent, more preferably equal to or greater than about 50 weight percent, more preferably equal to or greater than about 60 weight percent, more preferably equal to or greater than about 70 weight percent, and more preferably equal to or greater than about 80 weight percent based on the total weight of the carbonate block copolymer. When the carbonate block copolymer of the present invention does not contain silicon in the non-carbonate block(s) Component II), the oligomeric carbonate block(s) Component I) is present in an amount equal to or less than about 99.5 weight percent, preferably equal to or less than about 99 weight percent, more preferably equal to or less than about 97.5 weight percent, more preferably equal to or less than about 95 weight percent, more preferably equal to or less than about 92.5 weight percent, and more preferably equal to or less than about 90 weight percent based ion the total weight of the carbonate block copolymer.

When the carbonate block copolymer of the present invention contains silicon, preferably as poly(alkyl)siloxane in the silicon-containing non-carbonate block(s) Component II), the oligomeric carbonate block(s) Component I) is present in an amount equal to or greater than about 50 weight percent, preferably equal to or greater than about 70 weight percent, more preferably equal to or greater than about 75 weight percent, more preferably equal to or greater than about 30 weight percent, and more preferably equal to or greater than about 80 weight percent, more preferably equal to or greater than about 85 weight percent, and more preferably equal to or greater than about 90 weight percent based on the total weight of the carbonate block copolymer. When the carbonate block copolymer of the present invention contains silicon, preferably as poly(alkyl)siloxane in the silicon-containing non-carbonate block(s) Component II), the oligomeric carbonate block(s) Component I) is present in an amount equal to or less than about 99.5 weight percent, preferably equal to or less than about 99 weight percent, more preferably equal to or less than about 98 weight percent, more preferably equal to or less than about 97 weight percent, more preferably equal to or less than about 96 weight percent, and more preferably equal to or less than about 95 weight percent based ion the total weight of the carbonate block copolymer.

Component II) one or more non-carbonate block. If the non-carbonate block contains silicon, it is a silicon-containing non-carbonate block. If the non-carbonate block does not contain silicon, it is a non-silicon-containing non-carbonate block. The non-carbonate block II), comprises a diamine moiety wherein each amine is bonded to an oligomeric carbonate block through a urethane group. Diamine compounds suitable for use as the divalent non-carbonate block II) moiety of the present invention are known and can be made by a number of processes. Such non-carbonate block diamine compounds are represented by the following formula VII:

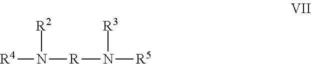

wherein

R², R³, R⁴, and R⁵ are independently hydrogen; a monovalent aliphatic radical such as a linear, branched, and/or cyclic aliphatic C₁ to C₂₅ hydrocarbon organic radicals, preferably methyl, ethyl, propyl, butyl, pentyl, hexyl, cyclohexyl, cyclooctyl, cyclododecyl; and/or an aromatic C₅ to C₂₅ radical comprising one or more aromatic rings, and/or an alkyl-aryl C₅ to C₂₅ radical wherein the aliphatic, aromatic, and/or alkyl-aryl radical may comprise one or more or a combination of an alcohol, ketone, ester, ether, aldehyde, oxirane;

and

R is selected from a linear or branched alkyl, aryl, or alkyl-aryl C₁ to C₂₅ hydrocarbon diradical, wherein the aliphatic, aromatic, and/or alkyl-aryl diradical may comprise one or more or a combination of an alcohol, ketone, ester, ether, aldehyde, oxirane, mercapto, S, —SO—, or —SO₂— groups; the alkyl and/or alkyl-aryl moieties may comprise one or more unsaturated bond; a heterocyclic diamine wherein the ring structure comprises the nitrogens of the diamine, such as piperazine, amino tetra hydropyrrol, amino pyrrolidin, amino indol, amino isantine, amino carbazol, gramine, tryptamine, hydantoin, amino oxazolane, amino oxazolindine, amino thiazole, and their derivatives; an oligomer block comprising repeating units of dihydric phenols disclosed herein above; and/or poly(alkyl)siloxanes. When —R— comprises a poly(alkyl)siloxane it is preferably represented by the following formula VIII:

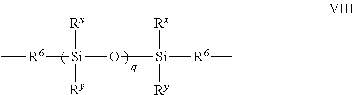

wherein

R⁶ is a C₂ to C₈ divalent aliphatic radical;

R^{x} and R^{y} are independently C₁ to C₁₃ monovalent organic radicals; and

q is an integer from 1 to 100 inclusive and has an average value of from 1 to 75, preferably 5 to 75, more preferably 10 to 60, more preferably 10 to 40.

R may further be represented by the formula IX:

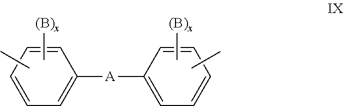

wherein

A, B, and x are defined herein above.

R, R¹, R², R³, R⁴, R⁵, R⁶, R^{x}, and/or R^{y} may independently comprise fluorine but not contain chlorine or bromine.

R², R³, R⁴, and R⁵ may not be a sulfur moiety, a silicon moiety, or a hydroxy group.

Some of the radicals included within R, R², R³, R⁴, R⁵ and R^{x}, and R^{y} are, for example, C₁ to C₂₅ alkyl radicals, preferably methyl, ethyl, propyl, butyl, pentyl, hexyl, heptyl, octyl, nonyl, undecyl, decyl, dodecyl, octadecyl, nonodecyl eicosyl, heneicosyl, docosyl, tricosyl, tetracosyl, pentacosyl and the isomeric forms thereof; C₆ to C₂₅ aryl radicals, preferably phenyl, tolyl, xylyl, napthyl, biphenyl, tetraphenyl and the like; C₇ to C₂₅ aralkyl radicals, inclusive, such as benzyl, phenethyl, phenpropyl, phenbutyl, phenhexyl, napthoctyl and the like; C₃ to C₈ cycloalkyl radicals, inclusive, such as cyclopropyl, cyclobutyl, cyclopentyl, cyclohexyl, cycloheptyl, cyclooctyl and the like.

Preferred radicals included in R^{x} and R^{y} are, for example C₁ to C₈ alkyl radicals, fluoroalkyl radicals, aryl radicals such as phenyl or tolyl. R^{x} and R^{y} are preferably methyl, ethyl, propyl, a mixture of methyl and trifluoromethyl, trifluoropropyl, and/or a mixture of methyl and phenyl.

Some of the radicals included within R⁶ are, for example, methylene, propylene, isopropylene, n-butylene, isobutylene, pentene, hexene, octene, and dodecene.

Suitable diamines may be primary, secondary, or tertiary diamines. In one embodiment the diamine contains silicon. In another embodiment, the diamine does not contain silicon.

Some of the diamines suitable for use in the present invention are ethylenediamine, propylenediamine, butylenediamine, pentylenediamine, hexylenediamine, octylenediamine, as well as N,N′-dimethyl ethane diamine, N,N′-dimethyl propane diamine, N,N′-dimethyl hexane diamine, polyether amines (e.g., Jeffamines), and the like.

Suitable hero-cyclic diamines are five-member rings such as amino tetra hydropyrrol, amino pyrrolidin, amino indol, amino isantine, amino carbazol, gramine, tryptamine, hydantoin, amino oxazolane, amino oxazolindine, and amino thiazole. Suitable hetro-cyclic diamines are six-member rings such piperazin, amino piperidine, cytosine, uracil, thymine, amino morpholine, amino thiazine, xanthine, and guanine. Such five- and six-membered rings can further be N-substituted to provide a secondary/tertiary diamine and/or bis-tertiary diamine, e.g., N-methyl piperazine, N,N′-dimethyl piperazine, N-ethyl piperazine, N,N′-diethyl piperazine, N-propyl piperazine, N,N′-dipropyl piperazine and the like, and the like.

In one embodiment of the present invention, the non-carbonate block II) does not contain silicon. In other words, in the formula VII above, R, R², R³, R⁴ and/or R⁵ are not silicone nor do they contain silicon.

In another embodiment of the present invention, the non-carbonate block II) comprises silicon, preferably as a poly(alkyl)siloxane, and more preferably as a polydimethylsiloxane.

When the carbonate block copolymer of the present invention does not contain silicon in the non-carbonate block(s) Component II), the non-carbonate block(s) Component II) is present in an amount equal to or greater than about 0.5 weight percent, preferably equal to or greater than about 1 weight percent, more preferably equal to or greater than about 2.5 weight percent, more preferably equal to or greater than about 5 weight percent, more preferably equal to or greater than about 7.5 weight percent, and more preferably equal to or greater than about 10 weight percent based on the total weight of the carbonate block copolymer. When the carbonate block copolymer of the present invention does not contain silicon in the non-carbonate block(s) Component II), the non-carbonate block(s) Component II) is present in an amount equal to or less than about 70 weight percent, preferably equal to or less than about 60 weight percent, more preferably equal to or less than about 50 weight percent, more preferably equal to or less than about 40 weight percent, more preferably equal to or less than about 30 weight percent, more preferably equal to or less than about 20 weight percent, based on the total weight of the carbonate block copolymer.

When the carbonate block copolymer of the present invention contains silicon, preferably as poly(alkyl)siloxane in the non-carbonate block(s) Component II), the silicon-containing non-carbonate block(s) Component II) is present in an amount equal to or greater than about 0.5 weight percent, preferably equal to or greater than about 1 weight percent, more preferably equal to or greater than about 2 weight percent, more preferably equal to or greater than about 3 weight percent, more preferably equal to or greater than about 4 weight percent, and more preferably equal to or greater than about 5 weight percent based on the total weight of the carbonate block copolymer. When the carbonate block copolymer of the present invention contains silicon, preferably as poly(alkyl)siloxane in the non-carbonate block(s) Component II), the silicon-containing non-carbonate block(s) Component II) is present in an amount equal to or less than about 50 weight percent, preferably equal to or less than about 30 weight percent, more preferably equal to or less than about 25 weight percent, more preferably equal to or less than about 20 weight percent, more preferably equal to or less than about 15 weight percent, more preferably equal to or less than about 10 weight percent, based on the total weight of the carbonate block copolymer.

The carbonate block copolymer of the present invention is prepared by reacting a mixture of oligomeric carbonate mono- and bis-chloroformates with a diamine VII. An oligomeric carbonate chloroformate is represented by the following formula X:

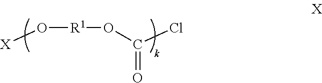

wherein

X is H⁺, Na⁺, a terminating group such as t-butylphenoxy radical, or

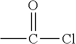

and

R₁ and k are defined herein above.

The carbonate oligomer chloroformates and carbonate block copolymers of the present invention may be made by any suitable polymerization process. A preferred method for preparing the carbonate oligomer chloroformates for use in the present invention involves the use of a carbonyl halide, such as phosgene, as the carbonate precursor. Preferably, the carbonate oligomer chloroformates and carbonate block copolymers of the present invention are prepared by an interfacial polymerization process which can be done either batchwise or continuously. Interfacial polymerization is well know; see for example the details provided in the U.S. Pat. Nos. 3,028,365; 3,334,154; 3,275,601; 3,915,926; 3,030,331; 3,169,121; and 4,188,314, all of which are incorporated herein in their entirety.

Although the reaction conditions of the preparative processes may vary, several of the preferred processes typically involve preparing a polymerization reaction mixture by dissolving or dispersing a dihydric phenol in water with a base, such as aqueous caustic soda or potash, adding the resulting mixture to a suitable water immiscible solvent medium and contacting the monomers with a carbonate precursor under controlled pH conditions, e.g., 8.5 to 14. The most commonly used water immiscible solvents include methylene chloride, 1,2-dichloroethane, chlorobenzene, toluene, and the like.

A carbonate precursor suitable for use in the present invention contains leaving groups which can be displaced from the carbonyl carbon in attack by the anion of a dihydric phenol compound, and includes but is not necessarily limited to carbonyl halides or acyl halides, of which, the most preferred is phosgene. The carbonate precursor, preferably phosgene, is contacted with the dihydric phenol compound in the aqueous alkaline solution and can be added as a solution in the water-immiscible non-reactive organic solvent and thoroughly mixed with the aqueous phase or can be bubbled into the reaction mixture in the form of a gas and preferentially dissolve and locate in the organic phase. The carbonate precursor is typically used in an amount of 1.0 to 1.8, preferably 1.2. to 1.5, moles per mole of dihydric phenol compound.

A chain terminator is a monofunctional compound containing a functional group, frequently a hydroxyl group, which will produce an anion capable of displacing an unreacted hydroxyl or carbonic acid ester group which remains on the end of the oligomer or polymer chain. Representative of the terminators which are useful for the production of polycarbonates in the present invention are phenol and the derivatives thereof, saturated aliphatic alcohols, alkyl acid chlorides, trialkyl- or triarylsilanols, monohalosilanes, amino alcohols, trialkyl alcohols, aniline and methylanaline. Of these, phenol, para-t-butyl phenol (PTBP), p-cumyl phenol and para-t-octyl phenol (4-(1,1,2,2-tetramethylbutyl)-phenol or PTOP) are the most preferred for use in the present invention.

In this process, the total amount of coupling catalyst is generally added in an amount equal to or greater than about 1 to about 150 millimoles (mmoles) per mole of dihydric phenol compound. The catalyst is preferably added in amounts equal to or greater than about 10, preferably at least about 25 and more preferably equal to or greater than about 50 mmoles per mole of dihydric phenol compound. The catalyst is preferably added in amounts equal to or less than about 150, preferably equal to or less than about 100 and more preferably equal to or less than about 75 mmoles per mole of dihydric phenol compound. Such coupling catalysts include a tertiary amine such as triethylamine (TEA), dimethyl amino pyridine or N,N-dimethyl aniline; a cyclic aza compound such as 2,2,6,6-tetramethyl piperidine or 1,2-dimethylimidazole; an iminoether or iminocarboxylate compound such as 1-aza-2-methoxy-1-cycloheptene or t-butyl-cyclohexyliminoacetate; or a phosphonium, sulfonium, arsonium or quaternary ammonium compound such as cetyl triethylammonium bromide. Tertiary amines are the preferred coupling catalysts for use in improved process according to the present invention and include trimethylamine, triethylamine, tributylamine, and 4-N,N-dimethylaminopyridine.

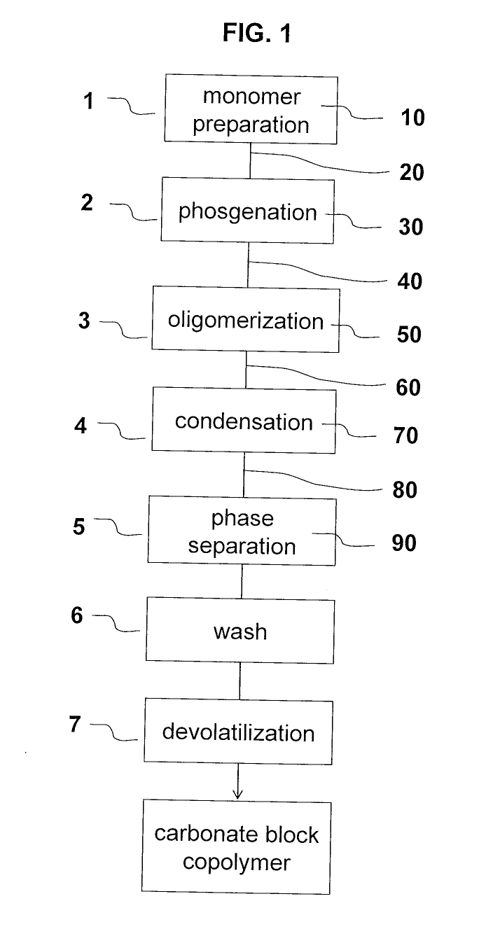

As is known, a standard interfacial process (also referred to as phase boundary process) for aromatic carbonate polymer polymerization (FIG. 1) involves the reaction of the dihydric phenol such as a bisphenol A, and the carbonate precursor such as phosgene or other disubstituted carbonic acid derivative, or a haloformate (such as a bishaloformate of a glycol or dihydroxy benzene). The initial stage of the interfacial process is the monomer preparation step 1. The dihydric phenol compound is at least partially dissolved and deprotonated in an aqueous alkaline solution to form bisphenolate (phenate). The carbonate precursor, typically phosgene, is supplied to the process 2, optionally dissolved in an inert organic solvent which forms the second of the two phases which initially serves as a solvent for the phosgene passed in, but in the course of the reaction also acts as a medium for the arylchlorocarbonates and oligocarbonates VIII formed during the oligomerization process 3.

The aqueous alkaline solution has a pH range from equal to or greater than about 9.5, preferably equal to about 14, preferably equal to or greater than about 12 to less than or equal to about 14, and can be formed in water by adding base such as caustic soda, NaOH, or other bases such as alkali metal and alkaline earth metal carbonates, phosphates, bicarbonates, oxides and hydroxides. Base is typically used over the course of the interfacial polymerization and further added to the reaction mixture where appropriate to maintain the proper pH. In total this usually amounts to the addition of base in an amount of 2 to 4, preferably 2.5 to 3.5, moles base per mole of dihydric phenol compound. The base, such as caustic soda, is added to the reaction mixture to adjust the pH of the mixture to a level at which the dihydric phenol compound is at least partially converted to dianionic form. A reducing agent such as sodium sulfite or sodium dithionite can also be advantageously added to the reaction mixture as well.

The other phase of the two phase mixture is a non-reactive organic solvent immiscible with water and in which the carbonate precursor and polycarbonate product are typically soluble. Representative solvents include chlorinated hydrocarbons such as methylene chloride, 1,2-dichloroethane, tetrachloroethane, chlorobenzene, and chloroform, to which tetrahydrofuran, dioxane, nitrobenzene, dimethyl sulfoxide, xylene, cresol or anisole may be added, if desired.

Both phases are mixed in a manner which is sufficient to disperse or suspend droplets of the solvent containing the carbonate precursor in or otherwise contact the precursor with the aqueous alkaline mixture. Reaction between the carbonate precursor and the phenate reactant in the aqueous phases yields primarily the bis-ester of the carbonate precursor with the dihydric phenol compound which can further react with more dihydric phenol units to form longer chain oligomers 3. Oligomer is defined as a polycarbonate chain having 25 or less repeating units. Some phenolic hydroxy groups do not react in this phosgenation step and remains as reactive groups but will react later with the chloroformate end-groups, formed in the phosgenation, and some remains as shorter chain, intermediate bis-esters. For example, if the carbonate precursor is an acyl halide such as phosgene, these intermediates are primarily bis-chloroformates, although some end groups may instead be a terminator residue, phenolate ion or unreacted hydroxy group.

The desired degree of oligomerization depends on several factors such as efficient mixing of the emulsion, the alkali content of the aqueous phase (e.g., reaction mixture pH), reaction temperature, residence times in different parts of the reactor sequence, the amount of terminator, etc. Typically, the polycarbonate forming reaction can be run at a pH from above 8.5 to 14, and at a temperature between 0° C. to 100° C., although usually not in excess of the boiling point (corrected for the operating pressure) of the solvent used. Frequently, the reaction is run at a temperature of 0° C. to 95° C.

If a branching agent is employed, it may be added 20 after the monomer preparation stage 1, 30 during or 40 after the phosgenation step 2, or 50 during or 60 after the oligomerization step 3.

The diamine may be added to the reaction process 40 following phosgenation step 2, 50 during the oligomerization step 3, or 60 after oligomerization step 3 is complete, but prior to condensation step 4. Once the oligomerization process has proceeded to the desired degree, the diamine is added to the reaction mixture.

When the diamine is a tertiary diamine, the coupling reaction between the amine and chloroformate proceeds through a quaternary ammonium salt via Hofmann degradation mechanism which requires the addition of a catalysis such as sodium bromide, sodium iodide, potassium bromide, potassium iodide, lithium bromide, lithium iodide, magnesium bromide, magnesium iodide, calcium bromide, or calcium iodide. Such a catalysis can be added to the reaction process once the tertiary diamine has been added at step 40 following phosgenation step 2, or at 50 during the oligomerization step 3, or at 60 after oligomerization step 3 is complete, but prior to condensation step 4. The catalysis is typically added in an amount of from 0.1 weight percent to 1 weight percent based on the weight of the aqueous phase.

With the addition of the coupling catalyst, the coupling reactions occur between ester moieties to couple/polymerize the oligomers into the carbonate polymer 4. The coupling catalyst may be added partially or wholly during 30, or at a point after phosgenation 40, 50, 60, or 70. Tertiary amines, specifically triethyl amine, are effective condensation catalysts. For instance, U.S. Pat. Nos. 6,225,436; 5,321,116; and 5,412,064 teach addition of the entire amount of catalyst at 30 or 40, 50 and 60, respectively.

The desired degree of polymerization depends on several factors such as efficient mixing of the emulsion, the alkali content of the aqueous phase (e.g., reaction mixture pH), reaction temperature, residence times in different parts of the reactor sequence, etc. Typically, the polycarbonate forming reaction can be run at a pH from above 8.5 to 14, and at a temperature between 0° C. to 100° C., although usually not in excess of the boiling point (corrected for the operating pressure) of the solvent used. Frequently, the reaction is run at a temperature of 0° C. to 95° C. The desired molecular weight of the polycarbonate is dictated by the ratio of monomer to chain terminator.

A chain terminator is typically used and can be added 10 or 20 to, with, or after the monomer preparation step 1, preferably 30 during or after phosgenation step 2, or 40, 50, 60, or 70 during or after the oligomerization and/or condensation steps, 3 and 4 respectively. Any terminator capable of attacking a hydroxyl, a chloroformate, or carbonic acid ester end group on a polymer chain is also capable of undesirably either (1) attacking unreacted molecules of the initial charge of the carbonate precursor or (2) displacing end groups before a chain has an opportunity to grow to the desired length. The practice in the art of adding chain terminator to the reaction mixture prior to introduction of the carbonate precursor consequently allows for the formation of undesired carbonate byproducts by the occurrence of both of the aforementioned results. Carbonate byproduct content detracts from the desirable properties and qualities of polycarbonate, and in most applications, may be seen as an impurity therein. For example, low molecular weight carbonates have a negative impact on the mechanical properties of the final polycarbonate composition.

The final stage of the interfacial process comprises obtaining the finished polycarbonate resin. Upon completion of polymerization, the organic and aqueous phases are separated 5 to allow purification of the organic phase and recovery of the polycarbonate product therefrom. The organic phase is washed as needed with dilute acid, water and/or dilute base until free of unreacted monomer, residual process chemicals such as the coupling catalyst and/or other electrolytes 6. Recovery of the polycarbonate product can be effected by spray drying, steam devolatilization, direct devolatilization in a vented extruder, precipitation by use of an anti-solvent such as toluene, cyclohexane, heptane, methanol, hexanol, or methyl ethyl ketone, or combinations thereof 7.

In the polycarbonates of the present invention branching agents may optionally be used and may comprise polyfunctional organic compounds containing at least three functional groups which may be hydroxyl, carboxyl, carboxylic anhydride, haloformyl and mixtures comprising at least one of the foregoing. Specific examples include trimellitic acid; trimellitic anhydride; trimellitic trichloride; tris-(hydroxy phenyl)ethane; isatin-bis-phenol; tris-phenol TC (1,3,5-tris((p-hydroxyphenyl)isopropyl)-benzene); tris-phenol PA (4(4(1,1-bis(p-hydroxyphenyl)-ethyl) α,α-dimethyl benzyl)phenol); 4-chloroformyl phthalic anhydride; trimesic acid; benzophenone tetracarboxylic acid, and the like. Preferably, the branching agent is tris(hydroxyphenyl)ethane (THPE).

If present, the branching agents may be added at a level equal to or greater than about 0.01 mole percent, preferably equal to or greater than about 0.05 mole percent, and more preferably equal to or greater than about 0.1 mole percent relative to the amount of dihydric phenol. The branching agents may be added at a level equal to or less than about 2 mole percent, preferably equal to or less than about 1 mole percent, and more preferably equal to or less than about 0.5 mole percent relative to the amount of dihydric phenol.

In the polycarbonates of the present invention a chain terminator may optionally be used. Suitable chain terminators include monovalent aromatic hydroxy compounds, haloformate derivatives of monovalent aromatic hydroxy compounds, monovalent carboxylic acids, halide derivatives of monovalent carboxylic acids, and mixtures thereof. Examples of chain terminators include, but are not limited to, phenol; p-tert-butylphenol; p-cumylphenol; p-cumylphenolcarbonate; undecanoic acid; lauric acid; stearic acid; phenyl chloroformate; t-butyl phenyl chloroformate; p-cumyl chloroformate; chroman chloroformate; octyl phenyl; nonyl phenyl chloroformate; or a mixture thereof. If present, the chain terminator is present in an amount equal to or greater than about 1 mole percent, preferably equal to or greater than about 2 mole percent, and more preferably equal to or greater than about 3 mole percent relative to the dihydric phenol. If present, the chain terminator is present in an amount equal to or less than about 10 mole percent, preferably equal to or less than about 8 mole percent, and more preferably equal to or less than about 5 mole percent relative to the dihydric phenol.

In general, desirable weight average molecular weights for the carbonate block copolymer of the present invention are equal to or greater than about 10,000 gram per mole (g/mole), preferably equal to or greater than about 16,000 g/mole, more preferably equal to or greater than about 18,000 g/mole, more preferably equal to or greater than about 20,000 g/mole, more preferably equal to or greater than about 22,000 g/mole, and even more preferably equal to or greater than about 25,000 g/mole. In order to obtain polymer with minimized levels of gels and other beneficial effects, it has been found that the weight average molecular weight of the carbonate block copolymer of the present invention should be equal to or less than about 100,000 g/mole, preferably equal to or less than about 80,000 g/mole, preferably equal to or less than about 60,000 g/mole, preferably equal to or less than about 45,000 g/mole, preferably equal to or less than about 40,000 g/mole, and more preferably equal to or less than about 35,000 g/mole. Unless otherwise noted, weight average molecular weight is intended when referring to molecular weight.

In another embodiment, the carbonate block copolymer composition of the present invention comprises a carbonate block copolymer and one or more additional thermoplastic blending polymer. Suitable thermoplastic blending polymers include, but are not limited to polycarbonates (PC) different from the carbonate block copolymer of the invention; polyolefins (PO) such as polyethylene homo- and copolymers, and polypropylene homo- and copolymers; polyolefin elastomers (POE), such as substantially linear ethylene polymers or one or more linear ethylene polymers (S/LEP); polyesters, such as polyethylene terephthalate (PET) and polybutylene terephthalate (PBT); polyphenylene sulfides (PPS); polysulfane (PSU); polyacetals; polyphenylene oxide (or ether) (PPO or PPE); polyamides (PI); styrenic polymers, such as polystyrene (PS), high impact polystyrene (HIPS), styrene and acrylonitrile copolymer (SAN), acrylonitrile, styrene, and acrylic ester copolymer (ASI), acrylonitrile, ethylene-propylene, and styrene copolymer (AES), styrene and maleic anhydride copolymer (SMI), impact modifiers, for example butyl rubber, chlorinated polyethylene rubber (CPE), chlorosulfonated polyethylene rubber, an olefin polymer or copolymer such as ethylene/propylene copolymer (EP), ethylene/styrene copolymer (ES), ethylene, propylene, and diene copolymer (EPDM), styrene, ethylene and butadiene terpolymer, a styrene and butadiene polymer, a styrene and ethylene polymer, an alpha olefin polymer or copolymer, styrene, ethylene, butylene, and styrene block copolymers (SEBS), core shell type rubbers such as methylmethacrylate, butadiene, and styrene (MBS); a silicon-containing graft copolymer, preferably a silicon-containing graft (co)polymer having a core-shell morphology, including a grafted shell that contains polymerized alkyl(meth)acrylate and a composite rubber core that contains polyorganosiloxane and poly(meth)alkyl acrylate components, a thermoplastic elastomer (TPE), an engineering thermoplastic elastomer (COPE), an urethane based engineering thermoplastic elastomer, a functional olefin polymer such as glycidyl (meth)methacrylate (GMI), methylmethacrylate (MMI), acrylic acid (AI) grafted polymers and copolymers, a recycled polymer composition, an olefin block copolymer (OBC), a liquid crystal polymer, and mixtures thereof. A most preferable thermoplastic polymer for blending with the carbonate block copolymer of the present invention is acrylonitrile-butadiene-styrene (ABS) copolymers, which are typically grafts of styrene or substituted styrenes and acrylonitrile or substituted acrylonitriles on a previously formed diene polymer backbone (e.g., polybutadiene or polyisoprene).

When more than one thermoplastic blending polymer is present, the individual thermoplastic blending polymers may be melt blended individually into the carbonate block copolymer composition of the present invention, they may be pre-melt blended together then added to (melt blended into) the polycarbonate block copolymer composition of the present invention, or a two or more may be pre-melt blended with additional ones melt blended individually.

Styrene and substituted styrenes are vinyl aromatic monomers having one or more alkyl, alkoxyl, hydroxyl or halo substituent groups attached to the aromatic ring, including, e.g., α-methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers.

Acrylonitriles are examples of “monoethylenically unsaturated nitrile monomers” which are acyclic compounds that includes a single nitrile group and a single site of ethylenic unsaturation per molecule. Other monoethylenically unsaturated nitrile monomers include, for example, methacrylonitrile and α-chloro acrylonitrile.

Suitable acrylonitrile-butadiene-styrene copolymers may be produced by any method known in the art. In a preferred embodiment of the present invention, a suitable ABS is a high rubber graft acrylonitrile-butadiene-styrene copolymer produced in a process which includes an emulsion polymerization step. The phrase “high rubber graft” refers generally to graft copolymer resins wherein at least about 30 weight percent, preferably at least about 45 weight percent of the rigid polymeric phase is chemically bound or grafted to the elastomeric substrate phase. Suitable ABS-type high rubber graft copolymers are commercially available from, for example, GE Plastics, Inc. under the trademark BLENDEX™ and include grades 131, 336, 338, 360, and 415. In another preferred embodiment of the present invention, a suitable ABS is one produced in a process which includes a mass polymerization step, so-called bulk ABS. In yet another embodiment of the present invention, the ABS may be one or more emulsion polymerized ABS and one or more mass ABS polymerized ABS.

The blending thermoplastic polymer, such as acrylonitrile-butadiene-styrene copolymer may typically be present in an amount equal to or greater than about 3 parts by weight, preferably equal to or greater than about 5 parts by weight, and more preferably equal to or greater than about 7 parts by weight based on the total weight of the composition. The blending thermoplastic polymer, such as acrylonitrile-butadiene-styrene copolymer may typically be present in an amount equal to or less than about 30 parts by weight, preferably equal to or less than about 20 parts by weight, more preferably equal to or less than about 15 parts by weight, and even more preferably equal to or less than about 10 parts by weight based on the total weight of the composition.

Flame retardant additives may optionally be used in the present invention in an amount equal to or greater than about 0.05 part by weight, preferably equal to or greater than about 0.1 parts by weight, preferably equal to or greater than about 0.5 parts by weight, more preferably equal to or greater than about 1 part by weight, more preferably equal to or greater than about 2 part by weight, and more preferably equal to or greater than about 5 parts by weight based on the total weight of the composition. Flame retardants may optionally be used in the present invention in a range equal to or less than about 30 parts by weight, preferably equal to or less than about 20 parts by weight, preferably equal to or less than about 15 parts by weight, and more preferably equal to or less than about 10 parts by weight based on the total weight of the composition.

A preferred flame retardant additive is one or more aromatic phosphorous compound which is represented by the following formula XI:

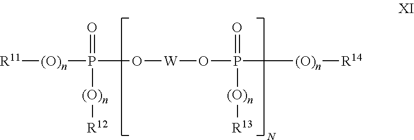

wherein,

R¹¹, R¹², R¹³ and R¹⁴ independently of one another each denote optionally halogenated C₁- to C₈-alkyl, or C₅- to C₆-cycloalkyl, C₆- to C₂₀-aryl or C₇- to

C₁₂-alkyl-aryl, in each case optionally substituted by alkyl and/or halogen,

W denotes a mono- or polynuclear aromatic radical having 6 to 30 C atoms,

n independently of one another is 0 or 1, and

N represents values from 0 to 30.

Preferred aromatic phosphorous compounds are monophosphates, for example triphenyl phosphate (TPP); oligomeric phosphates, for example resorcinol diphosphate (RDP) or Bisphenol-A-bis(diphenylphosphate) (BAPP); and mixtures thereof.

Other flame retardants that may also be included in the composition of the present invention in conjunction with, or in place of, phosphorous compounds, such as anti drip agents, such a polytetrafluoroethylene polymer (PTFE), a fluorothermoplast, or mixtures thereof; salts of sulfonic acids; halogenated compounds, preferably brominated compounds; and combinations thereof.

The carbonate block copolymer composition of the present invention may contain optional additives, such as a pigment or a dye, a tackifier, a mold release agent, a lubricant, a filler, a reinforcing material, a light diffusing agent, etc. Such optional additives are generally known in the art. The amount of a pigment or dye preferably is from 0.0001 to 5 weight percent, if present at all. Lubricants and tackifiers are typically present in an amount of from 0.01 to 2 weight percent. Preferred mold release agents are known esters of long fatty acids; their preferred amount is from 0.01 to 2 weight percent. Preferred fillers are glass fibers and/or talc, the preferred amount is from 1 to 20 weight percent. Preferred light diffusing agents are silicon dioxide (SiO₂), core/shell rubbers, or combinations thereof and are typically present in an amount of from 0.1 to 10 weight percent. All percentages are based on the weight of the carbonate block copolymer composition.

The polymer composition of the present invention may also contain a stabilizer, such as an anti-oxidant and/or a UV stabilizer. Examples of suitable stabilizers are a sulfur containing molecule, a phosphite, hindered phenol, hypophosphite, phosphonite and/or diphosphonite, such as tetrakis-(2,4-di-tert butylphenyl) biphenylene diphosphonite, hydroxide salt, metal oxide, a carbonate such as calcium carbonate, aluminum trihydroxide, a phosphate such as sodium phosphate are the preferred ones, etc. One or more stabilizers are preferably comprised in the carbonate block copolymer composition independently in an amount of from 0.01 to 5 percent, preferably from 0.05 to 2 percent, by the weight of the carbonate block copolymer composition.

When a blending thermoplastic polymer is used, the carbonate block copolymer of the present invention and the one or more blending thermoplastic polymer are conveniently blended by melting the starting resins together with some applied shear. An extruder is a suitable apparatus for performing the mixing operation. The mixture can be immediately melt-processed to form a specific article if desired such as a sheet, film or molded part. The mixture may also be co-extruded on or between sheets or films of other polymers. It is also possible to form the blend into particulates such as pellets to be melt-processed in a subsequent operation.

By virtue of their excellent chemical resistance and good mechanical, physical, rheological, and thermal properties the carbonate block copolymer compositions according to the present invention are suitable for the production of fabricated articles of many kinds, in particular those subject to stringent requirements with regard to mechanical properties and especially requiring good impact resistance and low heat release.

The carbonate block copolymer compositions of the present invention are thermoplastic. When softened or melted by the application of heat, the carbonate block copolymer compositions of this invention can be formed or molded into fabricated articles using conventional techniques such as compression molding, injection molding, gas assisted injection molding, overmolding with or onto a non-polymeric (for instance metal) or polymer substrate (for instance foam) or combination thereof, 2 k injection molding, rotational molding, calendaring, vacuum forming, thermoforming, extrusion and/or blow molding, alone or in combination. The carbonate block copolymer compositions can also be fabricated, formed, spun, or drawn into films, fibers, multi-layer laminates, or extruded into sheets and/or profiles.

In addition, the present invention provides shaped, formed, or molded articles comprising the carbonate block copolymer of the present invention. Such carbonate block copolymer compositions described herein can be used to produce fabricated articles or shaped articles such as: interior trim for rail vehicles, interior trim for large passenger transportation vehicles in general, more specifically interior trim for airplanes, interior and exterior automotive applications, enclosures for electrical devices containing small transformers, enclosures for information dissemination and transmission devices, enclosures and cladding for medical purposes, massage devices and enclosures therefore, toy vehicles for children, sheet wall elements, enclosures for safety equipment, hatchback spoilers, thermally insulated transport containers, apparatus for keeping or caring for small animals, articles for sanitary and bathroom installations, cover grilles for ventilation openings, articles for summer houses and sheds, and enclosures for garden appliances. Preferred fabricated articles include housings or enclosures such as for: power tools, appliances, consumer electronic equipment such as TVs, VCRs, DVD players, web appliances, electronic books, etc., or housings or enclosures such as for: information technology equipment such as telephones, computers, monitors, fax machines, battery chargers, scanners, copiers, printers, hand held computers, flat screen displays, connectors and plugs, semi-transparent coverings in building and construction, such as multiwall sheet roofing, thick solid sheet glass replacement, office and non office compartment separation shields, interior door windows, caravan windows, wasteable high temperature applications, food processing equipment, food storage applications, water storage applications, and the like.

In order that those skilled in the art will be better able to practice the present invention, the following examples are given by way of illustration and not by way of limitation.

### EXAMPLES

The synthesis of urethane carbonate copolymers of the present invention is affected by reacting oligomeric bis-aryl chloroformates with a diamine in accordance with the following reaction scheme:

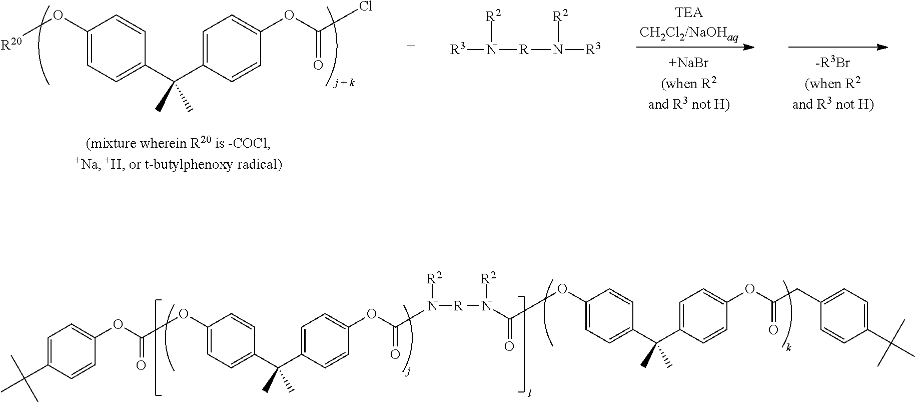

In Examples 1 to 3, oligomeric bis-aryl chloroformates are first isolated then reacted with a diamine. In Examples 4 to 8 the bis-aryl chloroformates are not isolated prior to reacting with the diamine.

The “polycarbonate oligomer intermediate” in Examples 1 to 3 are polycarbonate oligomers obtained from a 1 liter sample taken from a reaction mixture of a commercial interfacial phosgenation reaction of a mixture of bisphenol A and p-tertbutyl phenol in a 47:1 ratio. Approximately 1 liter of an interfacial polycarbonate reaction mixture containing oligomeric species dissolved in dichloromethane and aqueous carbonate buffer phase is washed with 10 weight percent HCl, providing a solution with a pH less than 5 and preserving the chloroformate groups against further chain growth reactions. The organic phase is washed three times with water, separated, dichloromethane removed, and the resulting solids dried under vacuum at 80° C. over night. The pre-polymers are checked for chloroformates, phenolic groups and oligomer content. Oligomers are defined as short polycarbonate chains below 25 repeating units and oligomer content is defined as the mass percent of oligomers based on the mass of the solid intermediate. The oligomers are characterized by number average molecular weight (Mn), in grams per mole (g/mole), weight average molecular weight (Mw) in g/mole, and by their polydispersity (D) which is the ratio of Mw/Mn.

Molecular weights are determined by gel permeation chromatography with PC standards. The chloroformate content is defined as mass percent of —O—(C═O)—Cl groups, based on the mass of the solid intermediate.

In Examples 1 to 3 the copolymerization reaction is performed in a carbonate buffer consisting of 0.2 molar NaOH, 0.1 molar Na₂CO₃ and 0.1 molar NaCl in demineralized water (Milipore grade) or in 1.5M NaOH solution. Dichloromethane is refluxed over P₂O₅ and distilled before use to remove stabilizers. The reaction progress is monitored by paper tape, impregnated with 4-(4-nitrobenzyl)-pyridine also referred to as phosgene detection tape.

¹H-NMR spectra is measured at 300 MHz (Varian Unity Innova Spectrometer). ¹H chemical shifts are given in parts per million (ppm) (δ) relative to tetramethylsilane (TMS) as an internal standard. Urethane carbonate block copolymer molecular weights are determined by Gel Permeation Chromatography (GPC) using a Shimadzu instrument equipped with two linear Shodex LF-804 columns with KD-G guard column. Data analyses is performed with LabSolutions software using the refractive index detector data. Chromatography (GPC) measurements of all primary amine modified copolymers are obtained using a Waters Breeze instrument equipped with two Waters Styragel columns (HT6E and HT3 or HT6E and HT2). Data analyses are performed with Breeze 3.0 software using the refractive index detector data. HPLC grade tetrahydrofuran (THF) from J. T. Baker is used as an eluent at a flow rate of 1 ml/min at 40° C. Quantification is made based on PS standard calibration.

### Example 1

5 grams of chloroformate terminated reactive polycarbonate oligomer intermediate having a Mn of 2,720 g/mole; a Mw of 4,480 g/mole; and 6.34 weight percent chloroformate end-groups is dissolved in 25 ml of pure dichloromethane resulting in a 15 weight percent solution. This mixture is brought to the desired temperature of 40° C. with agitation (500-750 rotations per minute (RPMs)) using a mechanical overhead stirrer at around 700 RPM. A 25 ml sample of an aqueous 1.5 weight percent disodium carbonate buffer solution, as described herein above, is added after the polycarbonate oligomers are fully dissolved. This provides a solution having a pH of about 10.5.

Then 5 weight percent (250 mg) of ethylene diamine is added (weight percent is based on the weight of the chloroformate terminated polycarbonate oligomers). The mixture is allowed to react for 30 minutes. Then 10 ml of triethylamine solution (0.25 g in 100 ml dichloromethane) is added and the pH adjusted to be greater than 10. The reaction progress is monitored with phosgene detection tape and reaches completion in about 10 minutes.

After the reaction is completed, the water phase is separated and the organic phase is washed two times with 10 percent HCl, two times with 0.1 molar sodium carbonate solution, and at least three time with water or until the pH is neutral. Finally, the organic phase is precipitated into methanol, filtered, and dried at 80° C. over night to yield a white fibrous polymer (90 to 95 percent yield).

The resulting urethane carbonate block copolymer has a Mn of 13,200 g/mole and a Mw of 31,100 g/mole.

### Example 2

5 grams of chloroformate terminated reactive polycarbonate oligomer intermediate having a Mn of 3,410 g/mole; a Mw of 2,610 g/mole; and chloroformate end-groups of 5.61 weight percent is dissolved in 25 ml of pure dichloromethane giving a 15 weight percent solution. This mixture was brought to the desired temperature of 40° C. with agitation (500-750 RPMs) using a mechanical overhead stirrer at around 700 RPM. A 25 ml sample of an aqueous 5 weight percent disodium hydrogen phosphate buffer solution is added after the polycarbonate oligomers are fully dissolved. This provides a solution having a pH of about 6.

Then 0.4 ml of an aqueous 0.2 molar sodium bromide or sodium iodide solution is added as Hofmann degradation catalyst. Followed by the addition of 0.5 g N,N,N′,N′,-tetramethyl-1,6-hexanediamine in 0.1 g increments. The reaction progress is monitored with phosgene detection tape and reaches completion after about 24 hours.

The molar mass of the formed polymer is measured by GPC after the following reaction times:

| | | | |
|---|---|---|---|
| 5 | min.: | Mn of 6,200 g/mole | Mw of 17,800 g/mole |
| 1 | hour: | Mn of 6,100 g/mole | Mw of 17,400 g/mole |
| 24 | hours: | Mn of 6,800 g/mole | Mw of 21,200 g/mole |

After the reaction 24 hours, the water phase is separated and the organic phase is washed two times with 10 percent HCl, two times with 0.1 molar sodium carbonate solution, and at least three time with water or until the pH is neutral. The organic phase is precipitated into methanol, filtered, and dried at 80° C. over night to yield a white fibrous polymer (90 to 95 percent yield).

### Example 3

5 grams of chloroformate terminated reactive polycarbonate oligomer intermediate having a Mn of 2,720 g/mole; a Mw of 4,480 g/mole; and 6.34 weight percent chloroformate end-groups is dissolved in 25 ml of pure dichloromethane resulting in a 15 weight percent solution. This mixture is brought to the desired temperature of 40° C. with agitation (500-750 RPMs) using a mechanical overhead stirrer at around 700 RPM. A 25 ml sample of an aqueous carbonate buffer solution, as described herein above, is added after the polycarbonate oligomers are fully dissolved providing a solution having a pH of about 10.5.

Then 0.9 g N-ethyl diamine terminated polydimethylsiloxane oligomers (about 18 percent by weight based on the weight of the chloroformate terminated polycarbonate oligomers) with a repeating Si unit (q) of about 40 is added. The mixture is allowed to react for 30 minutes. Then 10 ml of triethylamine solution (0.25 g in 100 ml dichloromethane) is added and the pH adjusted to be greater than 10. The reaction progress is monitored with phosgene detection tape and reaches completion in about 10 minutes.

After the reaction is completed, the water phase is separated and the organic phase is washed two times with 10 percent HCl, two times with 0.1 molar sodium carbonate solution, and at least three time with water or until the pH is neutral. The organic phase is precipitated into methanol, filtered, and dried at 80° C. over night to yield a white fibrous polymer (90 to 95 percent yield).

The resulting urethane carbonate-polydimethylsiloxane block copolymer has a Mn of 23,300 g/mole, a Mw of 46,400 g/mole, and a polydimethylsiloxane content as determined by ¹H NMR of about 23 weight percent based on the total weight of the urethane carbonate-polydimethylsiloxane block copolymer.

### Examples 4 to 8

In Examples 4 to 8 are performed in a jacketed reactor equipped with a condenser, pH probe, and thermometer. The reactor is flushed with N₂ and heated to 35° C. The reactants/solutions are added using Schott automatic dispensers. A Bisphenol-A solution of 2.28 g Bisphenol-A (10 mmole) in 20 ml of a 1.5 molar NaOH solution is added to the reactor followed by the addition of 15 ml dichloromethane. The following amounts of p-tertbutyl phenol terminator (PTBP) is added in form of a 1 weight percent solution in dichloromethane:

Example 4: 37.5 milligram (mg) (0.25 mmole)

Example 5: 37.5 mg (0.25 mmole)

Example 6: 30 mg (0.2 mmole)

Example 7: 30 mg (0.2 mmole)

Example 8: 60 mg (0.4 mmole)

Then 13 ml of 10 weight triphosgene solution in dichloromethane is added slowly keeping the temperature below 37° C. 10 min after adding the phosgenation, a 10 ml of a solution containing an amount of N-ethylaminoisobutyl terminated polydimethylsiloxane with a repeating Si unit (q) of about 40 in dichloromethane is added:

Example 4: 41 mg

Example 5: 68 mg

Example 6: 34 mg

Example 7: 20 mg

Example 8: 82 mg

After another 30 min, 10 ml of a triethylamine solution (0.25 g in 100 ml dichloromethane) is added and the pH is adjusted to be greater than 10. The reaction is completed in about 10 minutes, after no more chloroformate is detected with the phosgene detection tape. After the reaction is completed, the water phase is separated and the organic phase is washed twice with 10 percent HCl and three times with water. Finally, the organic phase is precipitated into methanol, filtered, and dried at 80° C. over night to yield a white fibrous polymer.

The resulting urethane carbonate-polydimethylsiloxane block copolymers have the following Mn, Mw, and percent by weight polydimethylsiloxane content based on the total weight of the copolymer and determined by ¹H NRM:

| | | | Polydimethylsiloxane |
|---|---|---|---|
| | | | content, weight |
| Example | Mn, g/mole | Mw, g/mole | percent |
| 4 | 20,200 | 37,200 | 17 |
| 5 | 24,100 | 45,700 | 37 |
| 6 | 26,000 | 49,800 | 17 |
| 7 | 20,800 | 41,100 | 11 |
| 8 | 14,900 | 26,800 | 41 |

What is claimed is:

1. A urethane carbonate block copolymer composition comprising a urethane carbonate block copolymer which comprises
I) from 99.5 to 50 weight percent of repeating or reoccurring carbonate oligomer block units of the formula I: 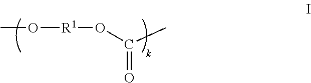
wherein
R¹ is a divalent aromatic residue of a dihydric phenol
and
k is an integer having an average value of from 2 to 25,
and
II) from 0.5 to 50 weight percent of a silicon-containing non-carbonate block of the formula II: 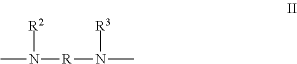
wherein
R is a poly(alkyl)siloxane of the formula VIII: 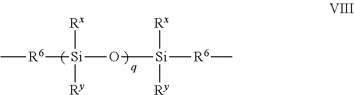
wherein
R⁶ is a C₂ to C₈ divalent aliphatic radical;
R^{x} and R^{y} are independently C₁ to C₁₃ monovalent organic radicals;
and
q is an integer from 1 to 100,
and
R² and R³ are independently hydrogen, a monovalent linear C₁ to C₂₅ aliphatic radical, a monovalent branched C₁ to C₂₅ aliphatic radical, a cyclic aliphatic C₁ to C₂₅ hydrocarbon organic radical, an aromatic C₅ to C₂₅ radical comprising one or more aromatic rings, an alkyl-aryl C₅ to C₂₅ radical wherein the aliphatic, aromatic, and/or alkyl-aryl radical may comprise one or more or a combination of an alcohol, ketone, ester, ether, aldehyde, or oxirane,
wherein the silicon-containing non-carbonate block is a diamine and each carbonate oligomer block joined to a silicon-containing non-carbonate block is joined through a urethane group.

2. An interfacial process for producing a urethane carbonate block copolymer from a dihydric phenol, a carbonate precursor, a silicon-containing diamine, a chain terminator, a coupling catalyst, and optionally a branching agent which process comprises the steps of:
a) combining a dihydric phenol, base, and water to form a polymerization reaction mixture,
b) adding a carbonate precursor and a water immiscible organic solvent to the polymerization reaction mixture,
c) partially oligomerizing the dihydric phenol in the polymerization reaction mixture b) to oligomeric carbonate mono- and bis-chloroformates with repeating units of from 2 to 25,
d) adding a chain terminator,
e) adding a silicon-containing diamine,
f) optionally adding a branching agent,
g) adding a coupling catalyst,
h) completing the polymerization reaction,
and
i) obtaining the urethane carbonate block copolymer.

3. A urethane carbonate block copolymer composition comprising a urethane carbonate block copolymer which comprises
I) from 99.5 to 30 weight percent of a repeating or reoccurring carbonate oligomer block units of the formula: 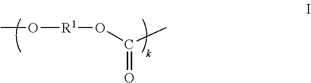
wherein
R¹ is a divalent aromatic residue of a dihydric phenol
and
k is an integer having an average value of from 2 to 25,
and
II) from 0.5 to 70 weight percent of a non-silicon-containing non-carbonate block of the formula: 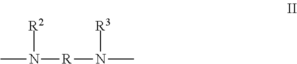
wherein
R is a linear or branched alkyl, aryl, or alkyl-aryl C₁ to C₂₅ hydrocarbon diradical, wherein the aliphatic, aromatic, and/or alkyl-aryl diradical may comprise one or more or a combination of an alcohol, ketone, ester, ether, aldehyde, oxirane, mercapto, S, —SO—, or —SO₂— groups; the alkyl and/or alkyl-aryl moieties may comprise one or more unsaturated bond; a heterocyclic diamine wherein the ring structure comprises the nitrogens of the diamine, such as piperazine, amino tetrahydropyrrol, amino pyrrolidin, amino indol, amino isantine, amino carbazol, gramine, tryptamine, hydantoin, amino oxazolane, amino oxazolindine, or amino thiazole
and
R² and R³ are independently hydrogen, a monovalent linear C₁ to C₂₅ aliphatic radical, a monovalent branched C₁ to C₂₅ aliphatic radical, a cyclic aliphatic C₁ to C₂₅ hydrocarbon organic radical, an aromatic C₅ to C₂₅ radical comprising one or more aromatic rings, an alkyl-aryl C₅ to C₂₅ radical wherein the aliphatic, aromatic, and/or alkyl-aryl radical may comprise one or more or a combination of an alcohol, ketone, ester, ether, aldehyde, or oxirane,
wherein the non-silicon-containing non-carbonate block is a diamine and each carbonate oligomer block joined to a non-silicon-containing non-carbonate block is joined through a urethane group.

4. The urethane carbonate block copolymer of claim 3 wherein R is represented by the formula IX: 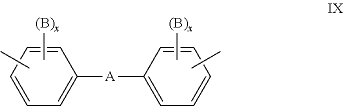
wherein
A denotes a single bond, a C₁-C₅ alkylene, a C₂-C₅ alkylidene, a C₅-C₆ cycloalkylidene, —O—, —SO—, —CO—, —S—, —SO₂—, or a C₆-C₁₂ arylene, on to which other aromatic rings, which optionally contain hetero atoms, can be condensed, or a radical of formula V or VI: 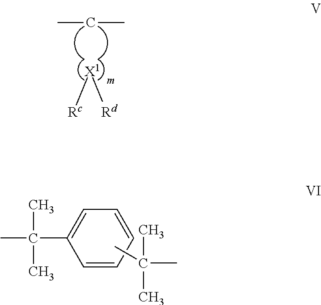
B in each case is independently hydrogen, a C₁-C₁₂ alkyl, preferably methyl, or a halogen, preferably chlorine and/or bromine;
x in each case is mutually independently 0, 1, 2, or 4;
p is 0 or 1;
R^{c} and R^{d} are mutually independent of each other and are individually selectable for each X¹ and are hydrogen or a C₁-C₆ alkyl, preferably hydrogen, methyl or ethyl;
X¹ denotes carbon;
and
m denotes an integer from 4 to 7, preferably 4 or 5, with the proviso that R^{c} and R^{d} simultaneously denote an alkyl on at least one X₁ atom.
